(19) United States
(12) Patent Application Publication
(10) Pub. No.: US 2013/0337852 A1
(43) Pub. Date: Dec. 19, 2013

(54) APPARATUS AND METHOD FOR MANY-TO-MANY MOBILE MESSAGING

(71) Applicant: Evolution Fund I Management Company Ltd., Tel Aviv (IL)

(72) Inventor: Eshed DONI, Or Yehuda (IL)

(73) Assignee: EVOLUTION FUND I MANAGEMENT COMPANY LTD., Tel Aviv (IL)

(21) Appl. No.: 13/871,020

(22) Filed: Apr. 26, 2013

Related U.S. Application Data
(63) Continuation of application No. 13/411,313, filed on Mar. 2, 2012, now abandoned.
Application No. 13/411,313 is a continuation of application No. 12/161,272, filed on Jul. 17, 2008, now abandoned.
(60) Provisional application No. 60/597,389, filed on Jan. 17, 2006.

(51) Int. Cl. H04W 4/12

(52) U.S. Cl. CPC H04W 4/12
USPC 455/466

(57) ABSTRACT

A many-to-many mobile messaging system and method comprising a mobile communication device operative to send a sequence of messages, wherein at least some of the messages are sent to a plurality of recipients and comprise message content and a set of destination indications for at least some of the plurality of recipients.

### REFERENCE TO CO-PENDING APPLICATIONS

The present application claims priority from U.S. provisional application No. 60/597,389, filed Jan. 17, 2006 and entitled “Providing many-to-many messaging using one-to-one messaging capabilities”.

### FIELD OF THE INVENTION

The present invention relates to mobile communications and specifically to mobile messaging.

### BACKGROUND OF THE INVENTION

Text messages are a popular personal communication mean. Text messages may be sent from a user of a mobile device such as a telephone to another user of a mobile phone.

Each text message is usually sent to a single recipient. This recipient is usually capable of replying by sending a text message to the originator of the original message. However, very frequently people would like to communicate with more than one person and have many-to-many messaging, commonly known as chat rooms/email/IM conferencing having several people each posting messages which can be seen by all the other people allowing them to respond so that all the others can see the response.

The state of the art is believed to be represented by the following patent and non-patent documents and products: GSM 03.19; GSM 03.40; 3GPP TS 23.040—Technical realization of Short Messaging Service (SMS); 3GPP TS 22.140—MMS Stage 1; 3GPP TS 23.140—MMS Stage 2; and ISO/IEC 21989—Information technology—Telecommunications and information exchange between systems—Private Integrated Services Network—Specification, functional model and information flows—Short message service; OMA Instant Messaging and Presence Service (IMPS) specifications; Mobile Instant Messaging (IM); Motorola Talkabout T900 personal interactive communicator; Nokia Friends Talk; Nokia Smart Messaging; and Upoc messaging.

The disclosures of any publications mentioned in the specifications, and of the publications cited therein directly or indirectly, are hereby incorporated, by reference.

### SUMMARY OF THE INVENTION

The following definitions are employed in the context of the present to specification. Each of the following constitutes one suitable definition for the respective terms; alternative definitions known in the art can also be applied to the various terms appearing herein.

| Term | Definition |
|---|---|
| SMS | Short Messaging Service. A system used |
| | to deliver textual messages. Other alternative |
| | definitions of the term “SMS” are provided |
| | herein. The term “SMS” when used herein applies |
| | to any and all of the various definitions, unless |
| | inappropriate. |
| SMS Message | A message delivered via SMS |
| Text message | A logical textual message. Each message |
| | has an originator and 1 or more recipients. Each |
| | message contains content. Technically, a text |
| | message may be implemented as an SMS |
| | message. |
| Message | A text message |
| Message originator | The sender of a message |
| Message recipient | A recipient of a message |
| Recipient ID | A unique identifier of a message recipient |
| One-to-one | A message which has a single originator |
| message | and a single recipient. |
| One-to-many | A message which has a single originator |
| message | and several recipients. |
| Message sequence | A collection of messages which is created |
| | by a message, a response to this message, a |
| | response to the previous response, etc. A message |
| | sequence is usually sorted chronologically |
| Original message | The first message chronologically in a |
| | message sequence |
| Many-to-many | A message sequence in which each |
| messaging | message is a one-to-many message and each |
| | message recipient is capable of replying to the |
| | message originator and to all the other message |
| | recipients |
| EMS | Enhanced Messaging Service. An extension to |
| | SMS. An EMS enabled mobile phone can send |
| | and receive messages that have special text |
| | formatting (such as bold or italic), animations, |
| | pictures, icons, sound effects and special ring |
| | tones. |
| MMS | Multimedia Messaging Service. A standard for a |
| | telephony messaging systems that allow sending |
| | messages that includes multimedia objects |
| | (images, audio, video, rich text) and not just text |
| | messages as in SMS. |

It is an object of a preferred embodiment of the present invention to provide a system and method for group dialogue via a cellular telephone network or any other communication network which significantly limits message length.

It is another object of another preferred embodiment of the present invention that provide group dialogue over communication networks that only provide one-to-one messaging capabilities.

It is another object of another preferred embodiment of the present invention, to facilitate the delivery of many-to-many messaging using simple text messaging capabilities and specifically existing SMS systems.

It is another object of another preferred embodiment of the present invention to provide a many-to-many messaging system which is based on a one-to-one messaging system, in which part of each one-to-one message is dedicated to an encoded representation of the IDs of message recipients, and in which a one-to-one message is sent to each such recipient or at least some of these recipients.

In certain embodiments, to allow many-to-many messaging, the IDs of, typically, all the message recipients other than the actual recipient of the one-to-one message, are encoded onto the message itself. This is in addition to the IDs of the message originator and the message recipient which are typically transferred as part of each message by default. The same text message is then sent to each recipient, the only difference between messages sent being, optionally, that the ID of the recipient of the one-to-one message is excluded from the list of IDs which is encoded on the message sent to this recipient. By decoding the IDs of all the message recipients, each recipient is capable of responding by sending messages to all the recipients of the original message.

Preferably, the recipient of a one-to-many message (which may be implemented by sending a series of one-to-one messages as described above) who wishes to respond to the message originator as well as to all the original message recipients (an action known as “reply-all”), decodes the IDs of all the message recipients, and responds with a one-to-many message which is then sent to the originator of the original message and to all the other recipients of the original message.

The process described above may be implemented in software which resides on a device which is used to send and receive text messages such as, for example, a mobile telephone.

An alternative SMS-based embodiment of the above system is now described. SMS messages contain text which is limited in its length. Each SMS message is sent to a single recipient. The recipient ID is the recipient's telephone number. Each SMS message contains the telephone number of its originator. To provide many-to-many messaging over an SMS message, a number of characters are reserved. The telephone numbers of all the message recipients are encoded onto these reserved characters. To minimize the number of reserved characters, thereby to maximize the number of characters usable for actual message content, the encoding process may include compression. Any suitable, typically lossless, text compression and encoding method may be employed such as but not limited to Dictionary Coders, Run-length Encoders, Borrow-Wheelers Transformators, Prediction by Partial Matching algorithms, Huffman Coding, and Arithmetic encoding.

A preferred embodiment of the invention showed and described herein allows users to send multi-recipient text messages. Every message recipient can either respond to the original message sender (like in a regular SMS message), or alternatively use either the “reply-to-some” or “reply-all” option and respond to some or all of the recipients of the original message. The ability to send multi-recipient messages and to answer received multi-recipient messages creates on-the-fly private chat rooms.

The system of the present invention preferably interfaces with the user's address book and updates the displayed contacts whenever the address book is updated.

To receive a multi-recipient message and even to respond to the sender of the original message, it is typically not required for users to be equipped with the system of the present invention. Preferably, the system of the present invention automatically promotes itself by automatically identifying users who do not have the system of the present invention, and providing these users with instructions as to where to obtain the system of the present invention.

The system of the present invention typically provides group management functionality, allowing users to predefine groups, transfer such definitions to other users either by letting users send group definitions to other users using messages which contain the IDs of all group members, which may be encoded and compressed, or by letting message recipients create on-the-fly groups made out of all the message recipients and the message originator. Upon receiving a multi recipient message, the message recipient may choose from an option on the menu to collect all the numbers in the message (i.e. sender and all recipients other than the one choosing the group option). The recipient may then be prompted to give the group a name. For example, if the system identifies that a user is sending a multi-recipient message to a plurality of recipients for which a group has not been defined previously, the user may be prompted to provide a name for a group that contains the recipients of the current message so that in future instead of selecting the recipients one-by-one it may be possible to simply address a message to the group and then to send messages to those groups.

Certain embodiments of the present invention also seek to provide a system and method for efficient group dialogue via a cellular telephone network or any other mobile communication network which strictly limits message size and/or is strictly limited to one-to-one messaging capabilities. Preferably, the mobile group dialogue system of the present invention has one, some or all of the following characteristics each described in detail herein which facilitate efficient group dialogue despite message size limitations:

a. Coding and compressing digits of cell numbers of group members, sent to other group members in the course of dialogue.

b. Placing a list of recipients at the end of a message or otherwise configuring such that the recipient need not view the recipient list; preferably the interface is such that viewing message content and viewing recipient list may be requested separately.

c. Omitting the recipient himself from the list of “other recipients” transmitted during dialogue, so as to take advantage of default attributes already included in the message, such as the actual recipient and the sender by removing these from the recipient list data provided in accordance with a preferred embodiment of the present invention.

d. Providing an interface allowing a definition of a group, including a group name, to be transferred from one user to another such that henceforth, only the name of the group, rather than the cell numbers of the members thereof, need be transmitted when messages are sent to all members of the group.

e. Message concatenation facilitation, preferably such that the list of other recipients appears only once in a sequence of concatenated messages.

f. Use of empty space, since most messages do not use all available characters e.g. all 70 or 160 characters.

g. Sending the recipient list data in binary format thereby separating it from the message's textual or other content. A particular advantage of this optional feature is that binary information may only be visible and accessible to applications but is not readable so that mobile users who do not have the application installed may not be aware of this information, while users who have the application, may see this information through the application.

There is thus provided, in accordance with a preferred embodiment of the present invention, a many-to-many mobile messaging method comprising:

sending a sequence of messages using a mobile communication device, wherein at least some of the messages are sent to a plurality of recipients and comprise message content and a set of destination indications for at least some of the plurality of recipients.

Further in accordance with a preferred embodiment of the present invention, at least one individual message is initiated by a user who has previously received a previous message including an individual set of destination indications and wherein the individual message is sent to at least some of the, destination indications in the individual set of destination indications.

Still further in accordance with a preferred embodiment of the present invention, at least some of the messages are sent over a cellular communication network and wherein the destination indications comprise cellular telephone numbers.

Additionally in accordance with a preferred embodiment of the present invention, the network comprises a mobile telephone network and wherein the destination indications comprise mobile telephone numbers.

Further in accordance with a preferred embodiment of the present invention, at least some of the messages comprise SMS messages, EMS messages, or MMS messages.

Still further in accordance with a preferred embodiment of the present invention, the sequence of messages comprises sets of at least first and second concatenated messages wherein the first contains at least a portion of desired content to be sent and wherein the second concatenated message comprises at least a portion of a distribution list. It is appreciated that the first and second messages can be sent in any desired temporal order and in general, the adjectives “first”, “second” etc. herein are used merely to distinguish and are not necessarily indicative of temporal or spatial order.

Further in accordance with a preferred embodiment of the present invention, at least some of the messages comprise text messages.

Still further in accordance with a preferred embodiment of the present invention, at least some of the messages are multimedia messages.

Also provided, in accordance with another preferred embodiment of the present invention, is a many-to-many mobile messaging system comprising a mobile sending encoder operative to receive from a user message content and indications of a plurality of recipients, each having a destination indication, to whom the user message content is to be sent, and to send a sequence of messages, wherein at least some of the messages are sent to the plurality of recipients and comprise the message content and a set of the destination indications for at least some of the plurality of recipients.

Further in accordance with a preferred embodiment of the present invention, the system also comprises a reply-processor operative to process at least one individual message initiated by a user who has previously received, from another sending encoder, a previous message including an individual set of destination indications and wherein the reply processor is operative to send the individual message to at least some of the destination indications in the individual set of destination indications.

Further in accordance with a preferred embodiment of the present invention, the sending encoder is located within a mobile communication device rather than within a central server.

Still further in accordance with a preferred embodiment of the present invention, the sequence of messages is sent over a network which transmits messages of limited size.

Further in accordance with a preferred embodiment of the present invention, the network comprises a cellular telephone network and wherein the messages comprise non-conversational messages.

Still further in accordance with a preferred embodiment of the present invention, the non-conversational messages comprise at least one message of at least one of the following types: SMS; EMS; and MMS.

Further in accordance with a preferred embodiment of the present invention, each message comprises a reserved portion storing the set of destination indications and wherein different reserved portions are of different sizes depending on the size of the respective set of destination indications.

Also provided, in accordance with another preferred embodiment of the present invention, is an interactive invitation system operative in conjunction with a mobile communication network and comprising at least one invitation encoder operative to receive from an inviter's mobile communication device, invitation content and indications of a plurality of invitees, each having a destination indication, to whom the invitation content is to be sent and to send, via a mobile communication network, a sequence of invitation messages, wherein at least some of the invitation messages are sent to the plurality of recipients and comprise the invitation content and a set of the destination indications for at least some of the plurality of invitees; and an invitation decoder operative to receive from an inviter's mobile communication device, vie the network, an invitation message comprising invitation content and a set of destination indications for at least some of a plurality of invitees' mobile communication devices, the invitation decoder being operative to display the invitation message to an invitee, to receive feedback from the invitee, and to communicate the feedback to at least a portion of the set of destination indications.

Further in accordance with a preferred embodiment of the present invention, the feedback comprises an accept/decline response to the invitation message.

Still further in accordance with a preferred embodiment of the present invention, the feedback comprises a proposed new time pertaining to the invitation message.

Also provided, in accordance with still another preferred embodiment of the present invention, is a mobile communication system comprising a multiplicity of mobile communication devices; a mobile communication hub operative to transmit messages between individual ones of the multiplicity of mobile communication devices, and wherein at least some of the mobile communication devices comprise: a recipient group definer operative to accept, store and subsequently send messages upon request to each member of, the mobile communication device user's definition of at least one group of recipients including telephone numbers thereof; a recipient group transmitter operative to transmit, upon request, the at least one group of recipients to at least one other mobile communication device user; and a recipient group receiver operative to receive from another mobile communication device, an incoming group of recipients and subsequently, to send messages upon request to each member of the incoming group of recipients.

Still further provided, in accordance with yet a further preferred embodiment of the present invention, is a mobile inter-consumer communication system comprising a multiplicity of inter-consumer communicators residing in a respective multiplicity of mobile communication devices, each communicator comprising a sending encoder operative to receive message content pertaining to a group discount offer and indications of a plurality of recipients, each having a destination indication, to whom the user message content is to be sent and to send a sequence of messages, wherein at least some of the messages are sent to the plurality of recipients and comprise the message content and a set of the destination indications for at least some of the plurality of recipients; and a group promotions status generator operative to receive, from individual ones of the multiplicity of mobile communication devices, accept messages pertaining to the group promotion and to generate a status indication of the group promotion by accumulating the accept messages.

Additionally provided, in accordance with another preferred embodiment of the present invention, is a mobile information diffusion system comprising a multiplicity of mobile communication devices each having an information diffusion mode of operation in which a message is sent to a plurality of recipients selected by the user of the mobile communication device and a confirming message is automatically sent to a defined recipient to confirm that the message has been sent to the plurality of recipients.

Further in accordance with a preferred embodiment of the present invention, the reply processor comprises a reply-all processor operative to send the individual message to all of the destination indications.

Still further in accordance with a preferred embodiment of the present invention, the reply processor comprises a reply-to-some processor operative to send the individual message to a designated subset of the destination indications.

Further in accordance with a preferred embodiment of the present invention, messages are sent directly between mobile users through a mobile network, without resort to a routing server.

Still further in accordance with a preferred embodiment of the present invention, the system also comprises a routing server operative to facilitate transmission of messages between mobile users.

### BRIEF DESCRIPTION OF THE DRAWINGS

Preferred embodiments of the present invention are illustrated in the following drawings:

FIG. 1 is a simplified block diagram illustration of a many-to-many mobile messaging system constructed and operative in accordance with a first, server-less embodiment of the present invention;

FIG. 2 is a simplified block diagram illustration of a server-centric many-to-many mobile messaging system constructed and operative in accordance with a second embodiment of the present invention which includes a many-to-many message processing server;

FIG. 3 is a simplified flowchart illustration of a first preferred method of operation for the server-less many-to-many messaging system of FIG. 1, in which a message is sent;

FIG. 4 is a simplified flowchart illustration of a second preferred method of operation for the server-less many-to-many messaging system of FIG. 1, in which a message is received and a reply thereto is sent to all recipients of that message;

FIG. 5 is a simplified flowchart illustration of a second preferred method of operation for the server-less many-to-many messaging system of FIG. 1, in which a message is received and a reply thereto is sent to some recipients of that message;

FIG. 6 is a simplified flowchart illustration of a first preferred method of operation for the server-centric many-to-many messaging system of FIG. 2, in which a message is sent;

FIG. 7 is a simplified flowchart illustration of a second preferred method of operation for the server-centric many-to-many messaging system of FIG. 2, in which a message is received and a reply thereto is sent to all or some recipients of that message;

FIGS. 8A-8D are simplified diagrams of a single message, constructed and operative in accordance with a preferred embodiment of the present invention, which is sent by a sender A to a plurality of recipients such as, in the illustrated embodiment, four recipients B, C, D and E;

FIG. 9 is a simplified diagram of a sequence of concatenated messages, constructed and operative in accordance with a preferred embodiment of the present invention, which is sent by a sender A to a recipient B as well as to other recipients such as, in the illustrated embodiment, recipients C, D and E;

FIG. 10 is a simplified diagram of a sequence of concatenated messages, constructed and operative in accordance with a preferred embodiment of the present invention, which has the same message content as in FIG. 9 but which is sent by sender A to recipient C;

FIG. 11 is a simplified diagram of a sequence of concatenated messages, constructed and operative in accordance with a preferred embodiment of the present invention, which has the same message content as in FIG. 9 but which is sent by sender A to recipient D;

FIG. 12 is a simplified diagram of a sequence of concatenated messages, constructed and operative in accordance with a preferred embodiment of the present invention, which has the same message content as in FIG. 9 but which is sent by sender A to recipient F;

FIGS. 13-28 are simplified pictorial illustrations of screenshots which together form a preferred user interface serving the users (senders and recipients) of any of the many-to-many messaging systems of FIGS. 1-7;

FIG. 29 is a simplified functional block diagram illustration of a mobile interactive invitation system constructed and operative in accordance with a preferred embodiment of the present invention;

FIG. 30A is a simplified flowchart illustration of a preferred method of operation for the outgoing invitation generator 890 of FIG. 29;

FIG. 30B is a simplified flowchart illustration of a preferred method for performing the one-to one message sending step by unit 1020 in FIG. 30A;.

FIG. 31A is a simplified flowchart illustration of a preferred method of operation for the incoming invitation reader 910 of FIG. 29;

FIG. 31B is a simplified flowchart illustration of a preferred method for performing the invitation decoding step by unit 1150 in FIG. 31A;

FIG. 32A is a simplified flowchart illustration of a preferred method of operation for the outgoing invitation response generator 920 of FIG. 29;

FIG. 32B is a simplified flowchart illustration of a preferred method for performing the one-to one message sending step by unit 1320 in FIG. 32A;

FIG. 33A is a simplified flowchart illustration of a preferred method of operation for the invitation response reader 930 of FIG. 29;

FIG. 33B is a simplified flowchart illustration of a preferred method for performing the invitation response decoding step by unit 1430 in FIG. 33A;

FIG. 34 is a simplified pictorial illustration of a first sequence of screenshots forming a first portion of a preferred user interface 900 serving users of the mobile interactive invitation system of FIG. 29, the first portion of the preferred user interface enabling users to initiate an event and to invite other users thereto;

FIG. 35 is a simplified pictorial illustration of a second sequence of screenshots forming a second portion of the preferred user interface 900 serving users of the mobile interactive invitation system of FIG. 29, the second portion of the preferred user interface enabling users to view a calendar of events they are committed to;

FIG. 36 is a simplified pictorial illustration of a third sequence of screenshots forming a third portion of the preferred user interface 900 serving users of the mobile interactive invitation system of FIG. 29, the third portion of the preferred user interface enabling users to view pending invitations which they may wish to accept or decline;

FIG. 37 is a simplified pictorial illustration of a fourth sequence of screenshots forming a fourth portion of the preferred user interface 900 serving users of the mobile interactive invitation system of FIG. 29, the fourth portion of the preferred user interface enabling users to define groups of contacts and preferably communicate such groups to others inside or outside that group;

FIG. 38 is a simplified functional block diagram of a mobile inter-consumer communication system constructed and operative in accordance with a preferred embodiment of the present invention;

FIG. 39 is a simplified pictorial illustration of a sequence of preferred screen shots for the customer management user interface 1905 of FIG. 38;

FIG. 40 is a simplified pictorial illustration of a sequence of preferred screen shots for the PC SMS-based marketing user interface 1920 of FIG. 38;

FIG. 41A is a simplified flowchart illustration of a preferred method of operation by which the promotion SMS sender 1930 of FIG. 38 sends group promotional messages

FIG. 41B is a simplified flowchart illustration of a preferred method for performing the send 1-to-1 message step by unit 2270 of FIG. 41A;

FIG. 42A is a simplified flowchart illustration of a preferred method of operation by which the promotion SMS sender 1930 of FIG. 38 sends referral offers;

FIG. 42B is a simplified flowchart illustration of a preferred method for performing the send 1-to-1 message step by unit 2420 of FIG. 42A;

FIG. 43 is a simplified flowchart illustration of a preferred method of operation for the forwarding SMS promotion unit 1970 of FIG. 38;

FIG. 44 is a simplified flowchart illustration of a preferred method of operation for the accept/decline message generator 1980 of FIG. 38;

FIG. 45A s a simplified flowchart illustration of a preferred method of operation by which the promotion SMS receiver 1990 of FIG. 38 receives referral offers;

FIG. 45B is a simplified flowchart illustration of a preferred method for performing the message decoding step by unit 2750 of FIG. 45A; and

FIGS. 46A-46B, taken together, form a simplified pictorial illustration of a sequence of preferred screen shots for the phone promotions application unit 200 of FIG. 38.

### DETAILED DESCRIPTION OF A PREFERRED EMBODIMENT

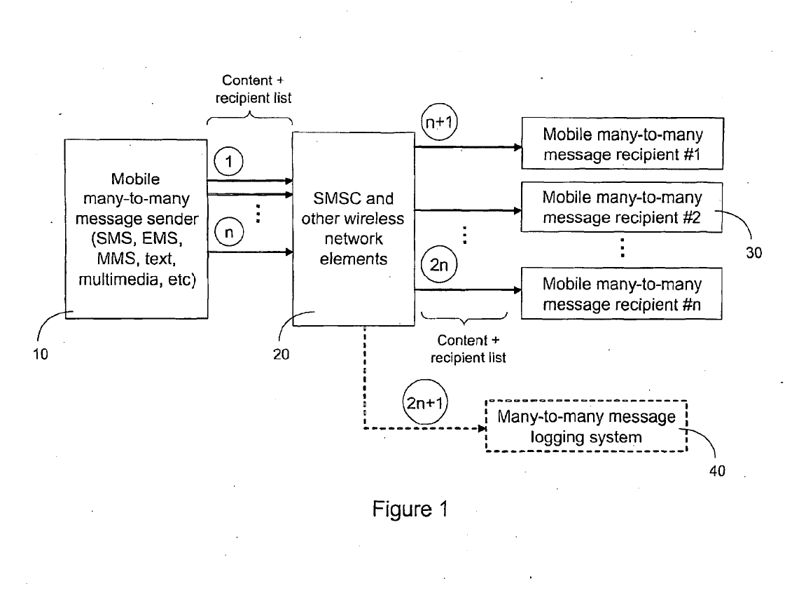

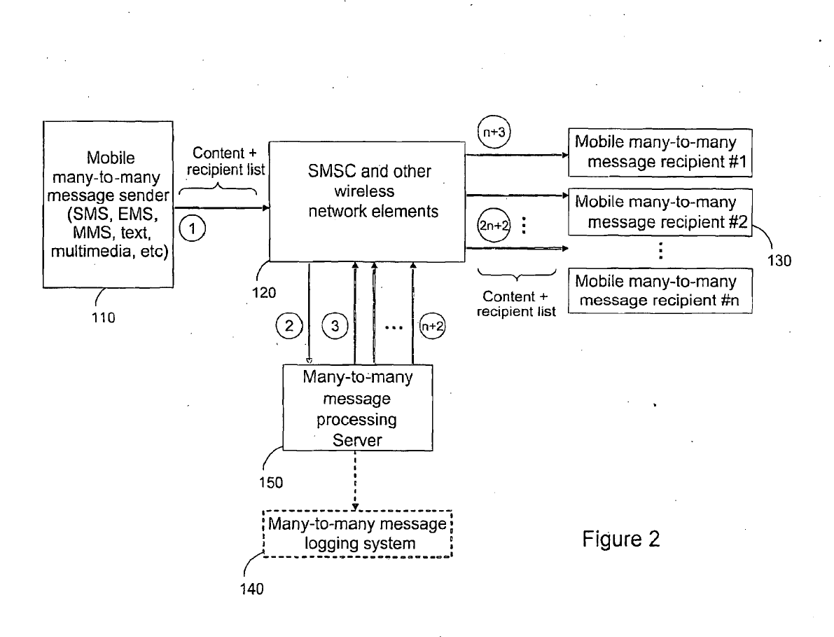

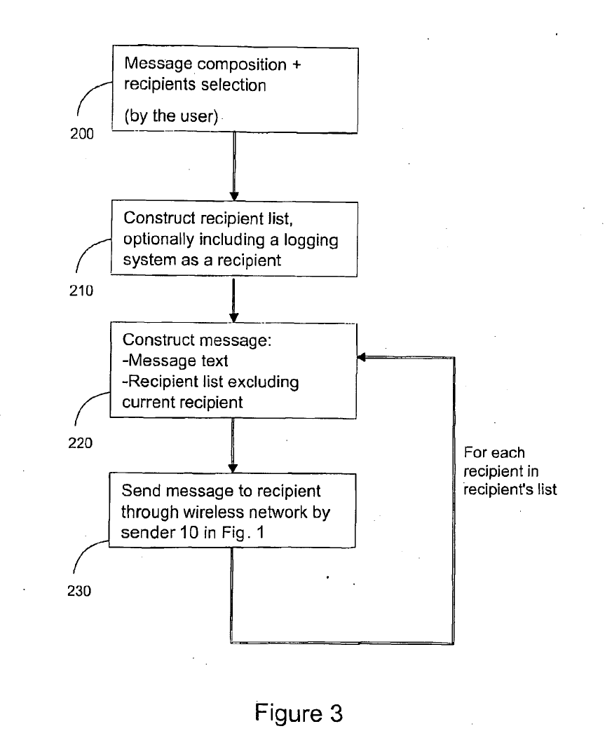

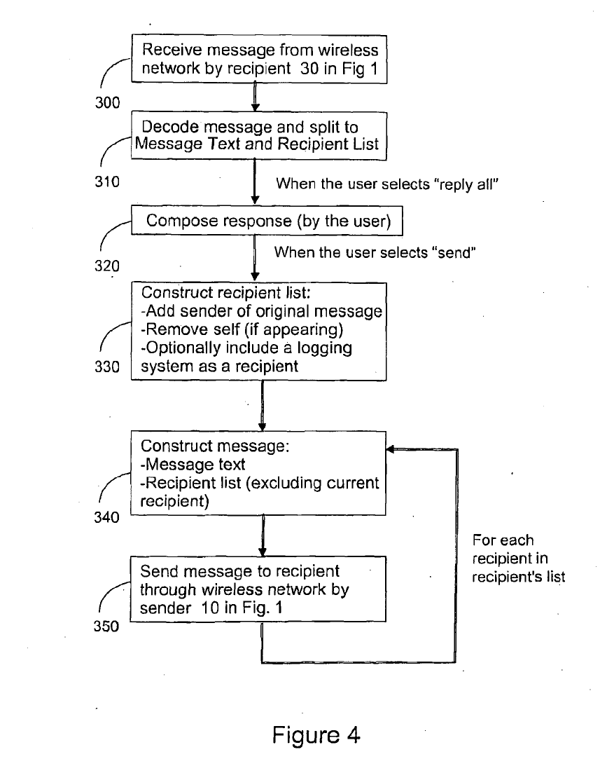

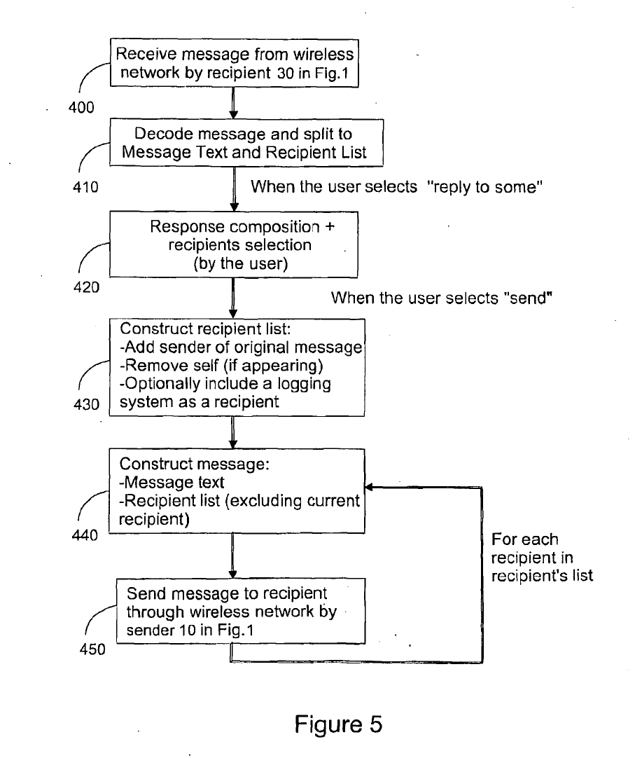

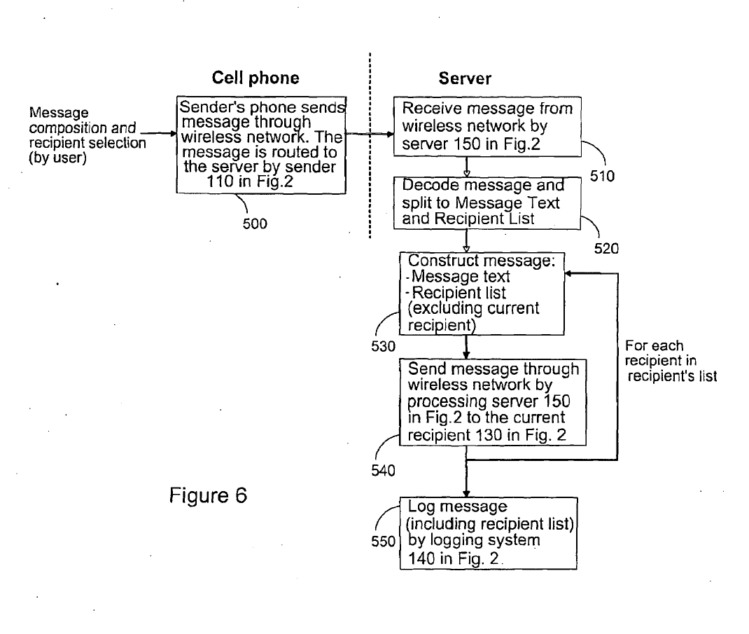

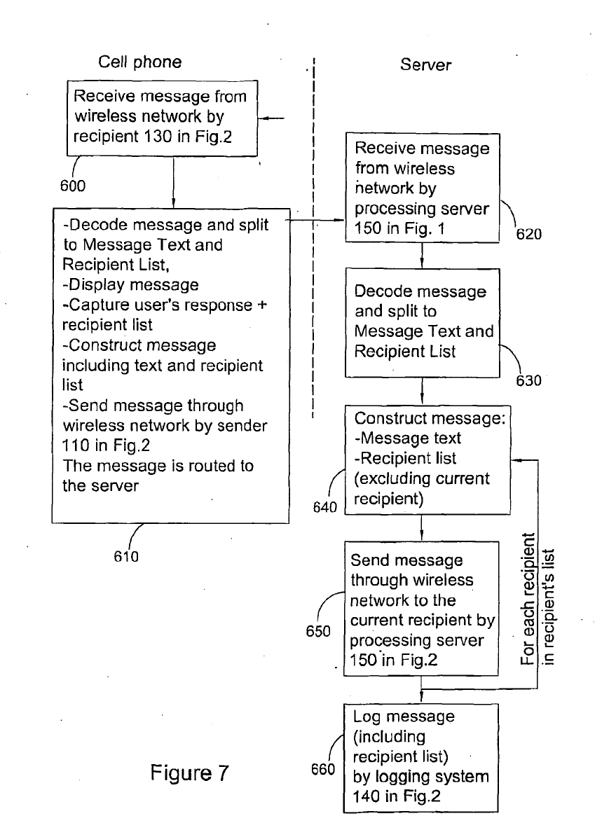

Reference is now made to FIG. 1 which is a simplified block diagram illustration of a many-to-many messaging system constructed and operative in accordance with a first, server-less embodiment of the present invention. The system of FIG. 1 includes a mobile sender 10 which resides on each of a multiplicity of mobile communication devices and is typically operative to receive an incoming message keyed in by a user of the mobile communication device, encode a plurality of messages such as SMS, EMS or MMS messages, corresponding in number to the number of message recipients 30 selected by the user message originator (typically although not necessarily a human), and send these messages out through a network 20 which is typically wireless, wholly or in part. As shown, many-to-many messages are preferably logged in which case the mobile sender 10 also sends a message to the optional many-to-many message logging system 40 which creates the log record and stores it. Optionally, over time, the log maps social networks of users preferably including weighting the interconnections between users to indicate the strength of the directional connections therebetween as evidenced by the volume or frequency of messages exchanged therebetween.

FIG. 2 is a simplified block diagram illustration of a server-centric many-to-many messaging system constructed and operative in accordance with a second embodiment of the present invention which includes a many-to-many message processing server 150. The server is typically operative to receive an incoming message from a sending user's mobile communication device 110, encode a plurality of messages such as SMS, EMS or MMS messages, corresponding in number to the number of message recipients selected by the sending user, and send these messages out through a wireless network 120 to a plurality of mobile users 130. As shown, many-to-many messages are preferably logged by a logging system 140 which creates the log record. Optionally, over time, the log maps social networks of users preferably including weighting the interconnections between users to indicate the strength of the directional connections therebetween as evidenced by the volume or frequency of messages exchanged therebetween.

FIG. 3 is a simplified flowchart illustration of a first preferred method of operation for the server-less many-to-many messaging system of FIG. 1, in which a message is sent. FIG. 4 is a simplified flowchart illustration of a second preferred method of operation for the server-less many-to-many messaging system of FIG. 1, in which a message is received and a reply thereto is sent to all recipients of that message. FIG. 5 is a simplified flowchart illustration of a third preferred method of operation for the server-less many-to-many messaging system of FIG. 1, in which a message is received and a reply thereto is sent to some recipients of that message.

FIG. 6 is a simplified flowchart illustration of a first preferred method of operation for the server-centric many-to-many messaging system of FIG. 2, in which a message is sent. FIG. 7 is a simplified flowchart illustration of a second preferred method of operation for the server-centric many-to-many messaging system of FIG. 2, in which a message is received and a reply thereto is sent to all or some recipients of that message.

The many-to-many messaging systems of FIGS. 1-7 are now described in detail.

Conventional mobile messaging solutions include:

a. One-to-one messaging: allowing a single sender to send a message to a single recipient. Some solutions allow the sender to specify a list of recipients causing an independent message to be sent to each recipient, without transferring any information regarding the other recipients and incapable of enabling any interaction with them

b. Mediation-server based solutions: the mediation server is the central repository of the distribution lists (also known as “groups”). The sender sends a message to the mediation server; the server associates the message with the appropriate distribution list and forwards the message to each of the users on this list. An example for a mediation server based mobile messaging solution is a chat room. The chat room server manages the list of users who are “in” every given chat room at any given time. The sender sends a single message to the server; the server associates the message with the relevant chat room, and forwards the message to all the users currently in the same chat room or to the specific one the user requested if he wanted a “side chat” with another member.

Conventional mediation-server based solutions are limited to predefined distribution lists. The distribution lists must be defined in advance on the server, before a message can be directed at the list. Sending a message to a group of recipients which is only known to the server or to an ad-hoc group is not supported. Also, pre-registration is typically required, due to the central management of distribution lists, users need to register prior to first use. Registration processes prevent ad hoc usage by definition and has proven to be a very high obstacle in getting many users to make use of it. Typically, there is no recipient list display the list of other recipients is not visible.

Conventional mediation-server based solutions also suffer from limited if any integration capability with device information and applications. The distribution lists are managed centrally and separately from the device and it is not possible to integrate the solution with information stored on the device, such as address book. Another drawback is deployment complexity: server-based solutions are complicated to implement, requiring more time, effort and a significantly higher investment. Conventional systems cannot be seamlessly integrated into existing infrastructure in contrast to preferred embodiments of the present invention shown and described herein. Specifically, the systems of FIGS. 1-7 preferably
Do not require a mediating server and may even be server-less as shown in FIG. 1;
Do not require pre-registration
Do not require predefinition of distribution lists
Have a component residing on the device to allow integration with information and functional units, such as software applications, residing on the device According to a preferred embodiment of the present invention, the systems of FIGS. 1-7 are operative to send a message to several recipients, letting each one of them see the other recipients, without the use of a mediating server. Preferably, the systems of FIG. 1-7 use a functional unit, which may be implemented in software, residing on the mobile communication device to construct, encode and send outgoing messages and to receive, decode and display incoming messages. This functional unit preferably interfaces with the address book information available on the mobile communication device. The functional unit lets the user select the desired recipients from the address book.

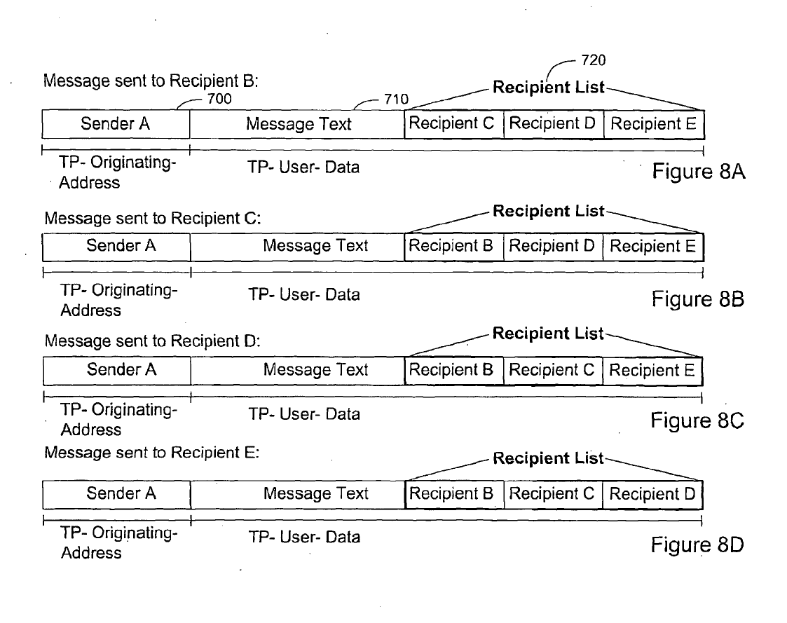

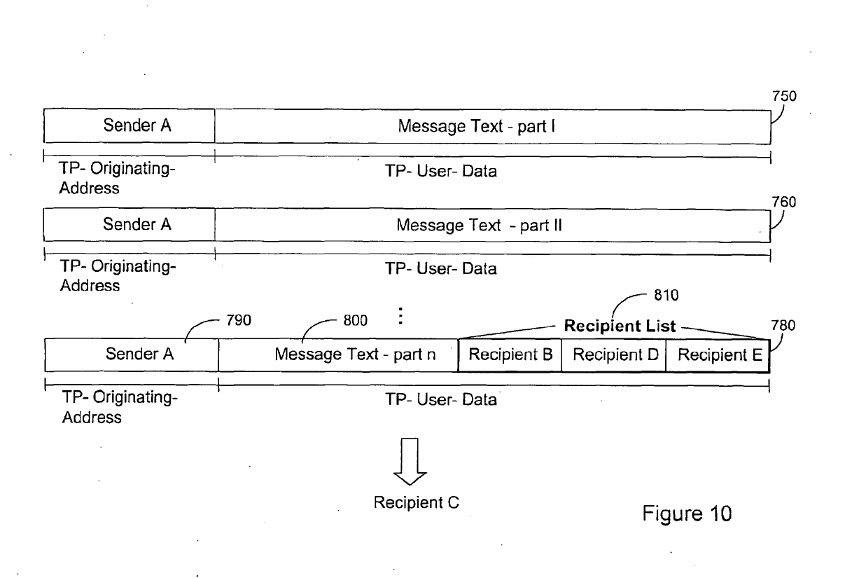

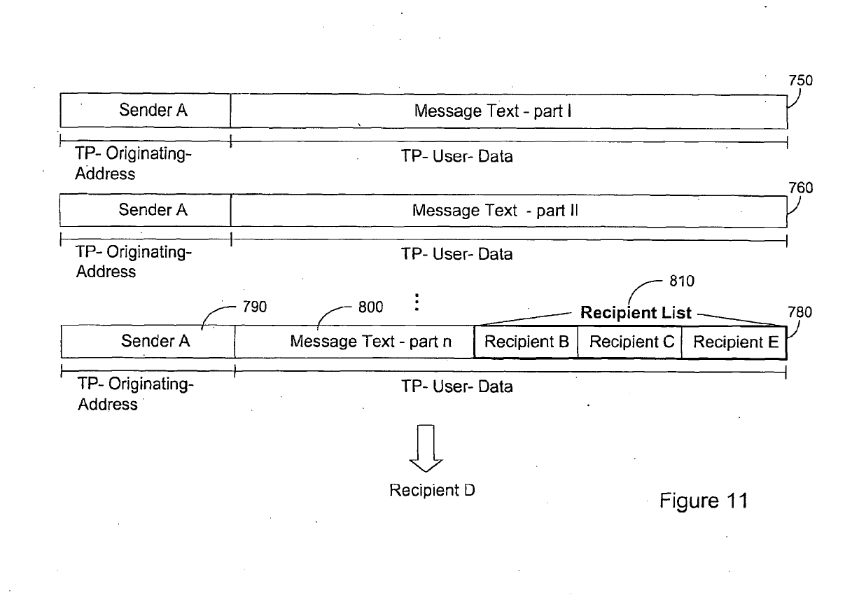

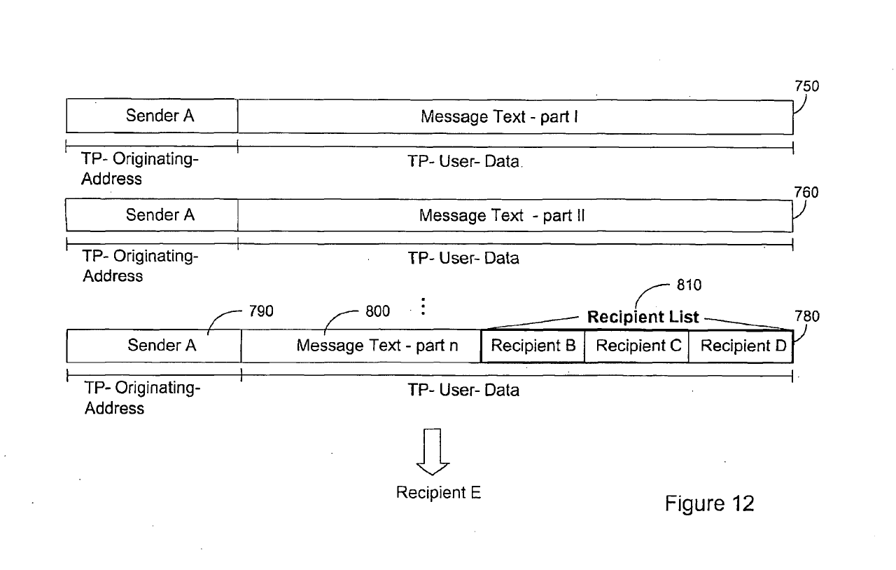

Preferably, once the user or “sender” selects the desired recipients for a message, then, for every recipient (“current recipient”) selected by the user:
The recipient list is revised to include all the recipients selected by the sender but preferably excluding the current recipient e.g. as shown in FIGS. 8-12.
A 1-to-1 message is sent to the current recipient, containing the original message text and the constructed recipient list

Preferably, once a user receives a message, a “reply all” option is provided. Whenever the recipient (“replier”) wishes to reply to all the other message recipients, the recipient list is created, typically as follows:
The sender of the original message (the one being replied to) is placed in the recipient list
All the recipients of the original message are placed in the recipient list
The replier is preferably excluded from the recipient list

For every recipient included in the recipient list (referred to as “current recipient” herein), the following operations are typically performed by the sender in the system of FIG. 1 or FIG. 2:
Revise the recipient list, including all the recipients selected by the sender but excluding the current recipient
Send a 1-to-1 message to the current recipient, containing the original message text and the constructed recipient list

To allow users of the system of the present invention to communicate with any other mobile user, the systems of FIGS. 1-7 preferably allow their users to send messages also to mobile users who do not have the system installed. In other words, an SMS (Short Messaging Service) message may be sent which is readable also to mobile users who do not have the decoding capability shown and described herein. To do this, the systems of FIGS. 1-7 preferably construct the SMS so that the message text appears first, using a textual representation, followed by the recipient list information which may be encoded. This enables each recipient to read the message text.

In certain embodiments of the invention, the decoding functional unit, e.g. that shown and described herein at reference numerals 300 and 310 in FIGS. 4, 400 and 410 in FIGS. 5, and 600 and 610 in FIG. 7, preferably registers for the event of the receipt of an incoming SMS. For recipients who have the decoding functional unit installed, the incoming SMS is intercepted by this functional unit which typically verifies that the received message is intended for the application, breaks the messages down thereby to separate the message text from the recipient list, decodes the recipient list and displays the message to the recipient in a clear representation, allowing each recipient to respond.

Recipients who do not have the decoding functional unit installed, typically receive the message as a regular SMS, can read it and can reply to sender using the SMS standard reply option. To ensure textual display (similar to that of regular text SMS) on SIM-based devices which do not have the decoding functional unit installed on them, the PID (Protocol ID) used in the SMS messages sent may be 0x00 and the DCS (Data Coding Scheme) may be 0x12.

In certain embodiments of the invention, users who do not have the system installed cannot decode the message at all.

Alternatively, the message text and the message recipient list may be sent using separate SMS messages. The SMS message(s) containing the message text are sect as regular textual SMS message(s) so that they are readable also by mobile users who do not have the decoding functional unit installed. The SMS message(s) containing the recipient list information are sent in a binary or other encoded format and are targeted at the decoding unit. In a SIM-based environment, for example, the SMS message(s) containing the recipient list information contains the specific TAR (Toolkit Application Reference) of the decoding functional unit. This SMS message typically triggers the decoding functional unit upon receipt and may be ignored if the system of the present invention is not installed on the mobile phone of the recipient.

To allow users of the system shown and described herein to communicate with any other mobile user, the systems of FIGS. 1-7 preferably allow users of the system to send messages also to mobile users who do not have the system installed

Optionally, after the message text, promotional text is added in a readable format. Mobile users, i.e. users of mobile communication devices which typically communicate via a wholly or partially wireless and/or cellular communication network, who do not have the decoding functional unit installed and receive incoming messages as regular SMS, can see the promotional text right after the message text. The decoding functional unit ignores the promotional text when decoding a message. The final result is that the promotional text is only displayed to mobile users who do not have the functional unit installed.

Preferably, the systems of FIGS. 1-7 do not reserve a fixed number of recipients and do not reserve a fixed number of characters to store recipient information. Instead, the systems of FIGS. 1-2 may assume a variable number of recipients and only reserve the space needed for the actual number of recipients.

To allow a variable number of recipients which does not require the sending and receiving functional units to agree in advance on the number of recipients, the number of actual recipients may be embedded in the message in a fixed location. This number can be located in various positions in the message. However, to make it unnoticeable to mobile users who do not have the decoding functional unit installed, the number is preferably located at the non-readable part of the message, i.e. after the actual message text and the optional promotional text.

The length of the actual message text and/or the length of the optional promotional text may not be known in advance. Therefore, an optimal position for the storage of the number of recipients is among the last characters of each message. If message concatenation is used, the order of the data required for message sequence information and the number of recipients may not be important. When sending messages, the encoding functional unit locates the number of recipients in the designated fixed position in the message. Upon receipt of an incoming message, the decoding functional unit retrieves the number of actual recipients and decodes the message accordingly.

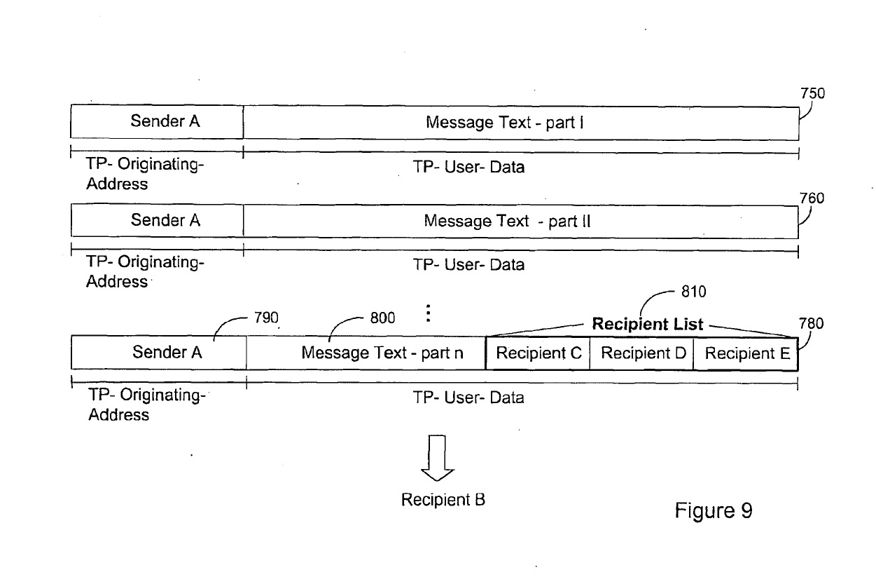

Typically, both the actual message text and the list of recipients thereof (the “recipient list”) is embedded onto SMS messages. Therefore, to allow long messages as well as long recipient lists, the systems of FIGS. 1-7 are typically able to handle messages which cannot fit a single SMS. Standard methods to concatenate SMS messages exist such as the one described in 3GPP TS 23.040. However, the existing methods for SMS concatenation may not be standard across various technologies and therefore, the message concatenation method illustrated in FIGS. 9-12 may be used.

To include the recipient list in the limited number of characters allowed for SMS messages (such as 160 characters) while leaving as much space as possible for the actual message text, the systems of FIGS. 1-7 may be characterized by some or all of the following characteristics:
To minimize the space required to store the recipient list information, this information is encoded and compressed
A variable number of recipients is used (see above) to minimize the space required for the recipient list information
When the encoded recipient list and the message together are still longer than the maximum number of characters e.g. 160, the message is split into several SMS messages, each containing an indication of its position within the SMS message sequence, the overall number of SMS messages in the message sequence and a unique identifier of the message sequence. The message sequence is typically created by the encoding functional unit which splits the message into a sequence of SMS messages. The decoding functional unit reconstructs the original message from the SMS messages contained in the message sequence by concatenating the text portions delivered by these SMS messages as illustrated by FIGS. 9-12.

The decoding functional unit can preferably distinguish SMS messages intended for it from all other SMS messages. Furthermore, if other SIM applications use similar SMS messages, the system of the present invention typically ignores the SMS messages targeted at other SEM applications. To distinguish between SMS messages targeted at the decoding functional unit and other SMS messages, including ones targeted at other applications, the systems of FIGS. 1-7 typically have one or both of the following characteristics:
The decoding functional unit is invoked for every incoming SMS and verifies the message format and bandies only messages received in the expected format
A unique application identifier is added to all the SMS messages sent by the encoding functional unit. The decoding functional unit only handles messages containing the unique identifier

An example of a typical use of the systems of FIGS. 1-7 is as follows:

Jim wants to send the same text message (e.g. asking to reschedule a meeting) to two colleagues of his: Shannon and Anila.(complex names . . . ) Jim uses the system of the present invention for this purpose. Due to the fact that messages are sent using SMS, Jim does not care whether Shannon and Anila are free or busy or whether their phone is turned on.

Shannon gets the message. As she has the system shown and described herein installed on her phone, she is immediately notified of the new incoming message. She reads the message and notices that the same message was also sent to Anila. Shannon clicks the ‘reply all’ option to say that she's OK with the newly suggested time for the meeting

Anila's mobile communication device does not have the system of the present invention installed therein. She therefore receives 2 regular SMS messages: one from Jim and then one from Shannon. The messages she gets may also inform her that if she had the system of the present invention installed, she would have had more options. However, until she installs the system of the present invention, she can only use the standard SMS reply option to separately send messages back to Jim and to Shannon.

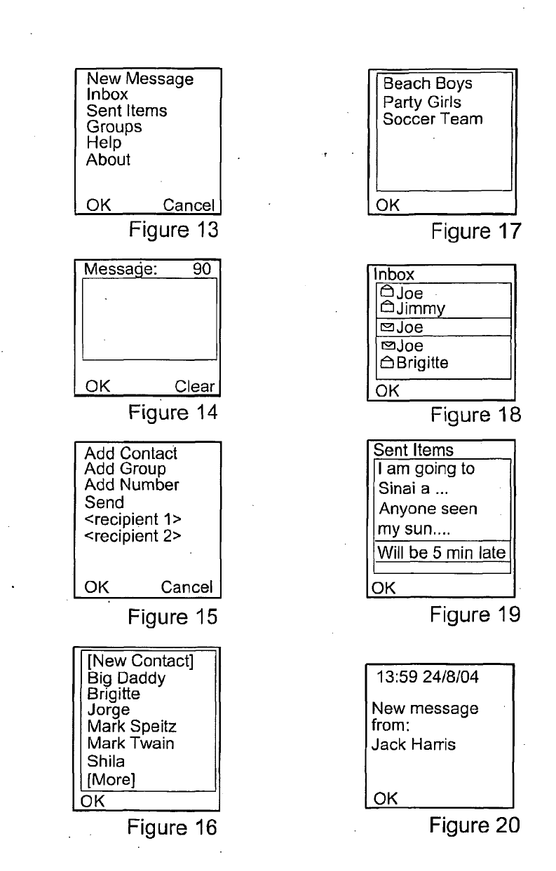

The systems of FIGS. 1-7 preferably include some or all of the following categories of functionalities (a)-(d), which are described in detail below with reference to the screenshot illustrations of FIGS. 13-28:

(a) Message sending functionalities such as the following: Send text messages to a number of recipients (FIGS. 13-16), Send text messages to predefined groups (FIGS. 13-15, 17), Select recipients from the address book (FIG. 16), Manually add recipients (FIG. 27), and Automatically send promotions to message recipients who are not users of the system of the present invention.

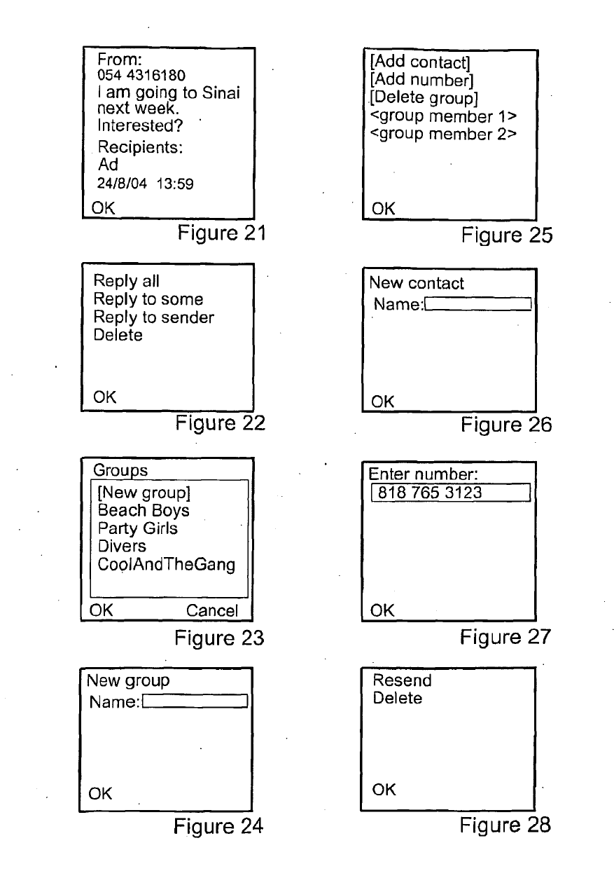

(b) Message receiving functionalities such as the following: Receive text messages (FIGS. 20-21), Receive messages when the system of the present invention is not running (the system of the present invention is launched automatically on the receipt of a new message), Receive messages without having the system of the present invention installed (these may be received as normal SMS messages), Reply to sender (FIG. 22), Reply to some (FIG. 22) and Reply to all (FIG. 22) (the recipients of the original message and the sender of the original message). Users who do not have the system of the present invention installed typically can only reply to the message sender (i.e. no reply-all or reply-to-some) and cannot see the other message recipients.

They may be able to see the numbers as part of the text but be unable to use them in the recipient list or reply to anyone other than the original sender (i.e. no reply-all)

(c) Group management functionalities such as the following: Define new groups (Every group contains a list of phone numbers and optionally a group name) (FIGS. 23-27), Update existing groups (FIGS. 23-27), Delete existing groups (FIG. 25), Transmit a group to another user.

(d) Message history functionalities: The most recent messages sent and received are preferably stored (for each message the sender/recipients, date and time, and content are preferably stored) (FIG. 18 for received messages, FIG. 19 for sent messages). Therefore, users can review sent messages

Users can review received messages, can resend sent messages, and can reply to received messages.

FIGS. 8A-8D are simplified diagrams of a single message, constructed and operative in accordance with a preferred embodiment of the present invention, which is sent by a sender A to a plurality of recipients such as, in the illustrated embodiment, four recipients B, C, D and E.

FIGS. 9-12 are simplified diagrams of a sequence of concatenated messages, constructed and operative in accordance with a preferred embodiment of the present invention, which is sent by a sender A to recipients B, C, D and E. The embodiment is useful e.g. when message content is very long or when it is desirable that the message content and the recipient list not be within the same message. To enable message recipients, such as recipient 30 in FIG. 1 or recipient 130 in FIG. 2, to decode concatenated messages they may receive, each message which is part of a sequence of messages representing a concatenated message may contain concatenation information e.g. one ore more of a unique message sequence ID, the overall number of messages in the message sequence and the position of the current message within the message sequence. The recipient typically verifies that all the messages of the message sequence have been received before using the concatenation information to process each of the messages, decode it, reconstruct the original concatenated message text and display it to the user.

FIGS. 13-28 are simplified pictorial illustrations of screenshots which together form a preferred user interface serving the users (senders and recipients) of any of the many-to-many messaging systems of FIGS. 1-7.

Reference is now made to FIG. 13 which is a simplified pictorial illustration of a Main Menu screen. The Main Menu is the first screen that is displayed when the user actuates the system of the present invention e.g. through the phone's menu (the other case of actuation of the system shown and described herein, is upon receipt of an incoming message). This screen acts as the root menu of the system of the present invention, and can preferably be accessed from any other screen e.g. by clicking CLR several times. The Main Menu is used by the user to navigate to any of the other screens. The user interface elements on the screen of FIG. 13 may for example include the following: OK and Cancel soft keys, and a menu including the following options: New Message, Inbox, Sent Items, Groups, Help, About and Exit. The default option when the system of the present invention is actuated is typically “New Message”. After the user selected an option and then returns to the main menu (e.g. by clicking CLR) the same highlighted option is preferably maintained.

User actions typically include: Up/Down arrows—scrolls up/down between the menu options; OK—selects the highlighted menu option and opens the corresponding screen as follows:

If the line highlighted or otherwise selected in the menu of FIG. 13 is the New Message line—the system opens the New Message screen of FIG. 14.

If the line highlighted or otherwise selected in the menu of FIG. 13 is the Inbox line—the system opens the Inbox screen of FIG. 18.

If the line highlighted or otherwise selected in the menu of FIG. 13 is the Groups line—the system opens the Groups screen of FIG. 23.

If the line highlighted or otherwise selected in the menu of FIG. 13 is the Help line—the system opens the Help screen.

If the line highlighted or otherwise selected in the menu of FIG. 13 is the About line—the system opens the About screen.

“Cancel” terminates the operation of the system shown and described herein.

Reference is now made to FIG. 14 which is a simplified pictorial illustration of a New Message screen. This screen is used by the user to type in the message content he wishes to send. The user interface (UI) elements may include: A Message text box—which may be limited in length e.g. to 100 or any other suitable number of alphanumeric characters, a Counter—showing the number of remaining characters, an OK soft key, and a Cancel soft key (changes to Clear when characters are entered).

User actions may include: 0-9 keys—displays the corresponding character in the message box (default handset behavior), and CLR—deletes a character/the previously displayed screen opens when there are no characters (either the Main Menu screen illustrated in FIG. 13 in which the New Message option may be highlighted or the Incoming Message Actions menu illustrated in FIG. 22).

Other optional keys include:
¢ key which switches between lower and upper case

# key—toggles between the input modes (multitap, T9, numbers, symbols, languages)

OK soft key—opens the New Message Recipients Screen or the Sent Items Actions menu when the message is from the Sent Items folder.

Reference is now made to FIG. 15 which is a simplified pictorial illustration of a New Message Recipients Screen. This screen is used to add/remove contacts, numbers and groups to the message recipients list and to finally send the message. User interface elements in the screen of FIG. 15 may include an Actions menu which may contain the following options:

Add Contact—adds a contact to the recipients list

Add Group—adds a group to the recipients list

Add Number—adds a number to the recipients list. That number is typically not stored for future use

Send—sends the message (this option is typically only available once at least 1 recipient has been selected for the message)

List of recipients already selected

Also, OK and Cancel soft keys may he provided.

User actions may for example include:

Up/Down arrows—scrolls up/down between the menu items

OK soft key

If the line highlighted or otherwise selected in the menu of FIG. 15 is the Add Contact line—the system opens the Contacts list screen of FIG. 16.

If the highlighted line is Add Group—the system opens the Groups list screen of FIG. 17.

If the highlighted line is Add Number—the system opens the Enter Number screen of FIG. 27.

If the highlighted line is Send—the system sends the message.

If the highlighted line is one of the recipients—the system opens a menu which facilitates removal of this recipient from the recipients list of the message and may also allow the user to add or modify the contact in the contacts or groups.

Responsive to the user pressing the Cancel soft key, the system closes the screen.

Reference is now made to FIG. 16 which is a simplified pictorial illustration of a Contacts list screen used to select contacts to be added to either the message's recipients list or a group. It is typically opened from the Message Recipients menu illustrated in FIG. 15 or the Group Actions menu illustrated in FIG. 25. User interface elements may for example include an OK soft key and a “Contacts list” which lists contacts which are retrieved from the accessible address books (e.g. the SIM address book where accessible, the phone address book where accessible or both). The first line in the list may be “[New Contact]”. In case not all contacts can be retrieved/displayed at once, the text of the last line may be “[More]”. In case [More] has already been used, the text of the first line may be “[Prey]”

User actions may include: Up/Down arrows which scroll up/down between the contacts. Responsive to the user's pressing the OK soft key

If the highlighted line is “New Contact”, the system opens the New Contact screen of FIG. 26.

If the highlighted line is “[More]”, the system retrieves more contacts and displays them in the Contacts screen of FIG. 16.

If the highlighted line is “[Prev]”, the system redisplays the previously displayed contacts in the Contacts screen of FIG. 16.

If the highlighted Line is a contact, the system adds the highlighted contact to the message recipients list/group and opens the Message Recipients screen/Group Members screen of FIG. 25.

Reference is now made to FIG. 17 which is a simplified pictorial illustration of a Groups List screen used to select groups to be added to the message's recipients List. The user interface elements in FIG. 17 may for example include an OK soft key and a “Groups list” which lists groups stored in and retrieved from an internal database storing groups which may have been previously defined by or imported by a user. The first line in the list is typically “[New Group]”. In case not all groups can be retrieved/displayed at once, the text of the last line may be “[More]”. In case [More] has already been used, the text of the first line may be “[Prey]”.

User actions may include: Up/Down arrows which scroll up/down between the contacts.

When a user presses the OK soft key

If the highlighted line is “[More]”, the system retrieves more groups and displays them in the Groups screen of FIG. 17.

If the highlighted line is “[Prev]”, the system redisplays the previously displayed groups in the Groups screen of FIG. 17.

If the highlighted line is a group, the system adds the highlighted group to a message recipients list which may be stored in an internal database of the system, and opens the Message Recipients screen of FIG. 15.

When a user sends a message it is preferably sent in the following format (the format of concatenated messages is described above): Messages are sent using 7 bit ASCII and GSM text compression. A message sent to N recipients, is physically sent as N SMS messages. The number of recipients of each message is limited to n recipients—an error message is displayed in case the user attempts to send a message to more than n recipients. n may be any suitable integer such as, for simple systems, 5. The text of each message may or may not be a priori limited to a ceiling number of characters e.g. 100 in which case the user cannot type more than 100 characters in the New Message screen.

The first n characters of the physical SMS may be known to contain the text of the message. When the system of the present invention receives an incoming message, these characters are extracted to the message text field. Characters n+1 onward (e.g. characters 101-120) of the physical SMS may contain an optional fixed promotional text. When the system of the present invention receives an incoming message, these characters are ignored. The next group of characters, e.g. characters 121-160, of the physical SMS may contain the encoded phone numbers of the message recipients, each recipient number encoded in 10 characters. As each physical SMS is sent to one “To:” mobile destination, the recipient associated with this destination, is typically excluded from the recipients encoded onto the SMS. When the system of the present invention receives an incoming message, these characters are extracted, decoded and displayed in the message recipients list of FIGS. 4-5.

Reference is now made to FIG. 18 which is a simplified pictorial illustration of an Inbox screen which lists received messages. The number of messages in the Inbox at any given time may be limited, e.g. to 20 (or less in case there is no space available). Each additional message typically overrides the oldest message in the inbox.

The user interface (UI) elements in FIG. 18 typically include an OK soft key and a “Messages list” in which each line represents one message. The line may contain an indication for the message status (read or unread) which is indicated by the leftmost character of the line, and may be followed by the sender's name or phone number. A name may be displayed for a sender who is a contact stored in the address book (either the SIM address book, the device's phone book or both); a number may be displayed for all other senders.

User actions typically include Up/Down arrows which scroll between the Inbox messages, an OK key (the Incoming Message screen opens with the information of the selected message) and a CLR key—the Main Menu of FIG. 13 is displayed when this is pressed.

Reference is now made to FIG. 19 which is a simplified pictorial illustration of a Sent Items screen which lists the messages sent. The number of messages in the Sent Items box at any given time may be limited e.g. to 20 (or less if there is no space available). Any additional message may override the oldest message in the Sent Items box.

UI elements may include: Messages list—each line may represent one message. The line may contain characters from the message's text and/or the recipient names and/or the date and time when the message was sent

OK soft key and Cancel soft key (e.g. on the right)

User actions may include:

Up/Down arrows—scroll between the Sent Items box messages

OK key—opens the New Message screen of FIG. 14 with the information of the selected message; and

CLR key—the Main Menu is displayed

Reference is now made to FIG. 20 which is a simplified pictorial illustration of a Incoming Message notification screen. This notification may be provided automatically on the receipt of an incoming message. UI elements may include:

Timestamp—the date and time when the new message has been received (read only text)

Notification text—the text of the notification (fixed text)

Sender name—the name of the sender as retrieved from the address book in case the sender's number was found in the address book. Otherwise, the sender's number (read only text); and

OK soft key.

User actions may include:

OK soft key—opens the Incoming Message screen of FIG. 21; and

CLR key—the previously displayed screen opens (either a screen of the system of the present invention or the mobile device's ordinary screen).

Reference is now made to FIG. 21 which is a simplified pictorial illustration of a Incoming Message screen used to display an incoming message and allow the user to respond. UI elements may include:

Timestamp—the date and time when the new message has been received (read only text);

Sender name—e.g. the name of the sender as retrieved from the address book in case the sender's number was found in the address book. Otherwise, the sender's number (e.g. read only text);

Message text—the text of the message (e.g. read only text);

Recipients list—the list of recipients (preferably excluding the current user). For each recipient whose number is found in the phone's address book, the recipient name associated with this number is displayed. The phone number may be displayed for all other contacts; and

OK soft key.

User actions may include:

Up/Down arrows—scroll through the message (in case the message is too long to fit into one screen);

OK soft key—opens the Incoming Message Actions menu of FIG. 22; and

CLR key—opens the Inbox screen.

Reference is now made to FIG. 22 which is a simplified pictorial illustration of a Incoming Message Actions menu which allows a message recipient specify how to respond to a received message. UI elements may include an Actions menu (which may contain some or all of the following options: Reply all, Reply to some, Reply to sender, Save numbers to contacts, create group and Delete), an OK soft key, and a Cancel soft key.

User actions may include Up/Down arrows—which scroll up/down between the menu items; and use of the OK soft key which may be as follows:

If the highlighted line is Reply All—opens the New Message screen of FIG. 14. Once the user clicks OK in this screen the message may be sent to the recipients of the original message including its sender, excluding the current sender.

If the highlighted line is Reply to Some—opens the New Message screen of FIG. 14. Once the user clicks OK in this screen, the New Message Recipients screen of FIG. 15 may open. All the recipients of the original message (including the sender of the original message, excluding the current sender) may be included in the list by default.

If the highlighted line is Reply to Sender—opens the New Message screen of FIG. 14. Once the user clicks OK in this screen the message may be sent to the original message sender.

If the highlighted line is Delete—deletes the current message and opens the Inbox screen of FIG. 18.

Cancel key—opens the Incoming Message screen of FIG. 14.

Reference is now made to FIG. 23 which is a simplified pictorial illustration of a Groups screen which lists all the defined groups and allows the user to add, delete and update group definitions. UI elements may include an OK soft key and a Groups list which contains all the existing groups retrieved from an internal database storing groups as described herein. The list may contain the following items: New Group line which if selected by the user creates a new group; and Groups—each line contains a name of a group.

User actions may include Up/Down arrows which scroll up/down through the list of groups, and the OK soft key whose actions may be:

If the “New Group” option is highlighted—opens the New Group screen of FIG. 24.

If one of the groups is highlighted—opens the relevant Group Members screen of FIG. 25.

CLR key—opens the Main Menu of FIG. 13.

Reference is now made to FIG. 24 which is a simplified pictorial illustration of a New Group screen which is opened via the Groups screen of FIG. 23. The screen of FIG. 24 is used to create a new group and assign it a name. UI elements may include: an OK soft key, and a Group name edit box which contains the Group's name (e.g. 1-20 alphanumeric characters).

User actions may include:

0-9 keys which display the corresponding character in the message box (default handset behavior), an OK soft key which opens the Group Members screen of FIG. 25, and a CLR key which opens the Groups screen of FIG. 23.

Reference is now made to FIG. 25 which is a simplified pictorial illustration of a Group Members screen which is opened via the Groups screen of FIG. 23. The screen of FIG. 25 is used to specify the Contacts that are included in the Group. UI elements may include an OK soft key, and an Actions menu which may contain some or all of the following options:

Add contact—adds a contact to the group

Add number—adds a number to the group

Delete group; and

Groups members.

User actions may include Up/Down arrows which scroll up/down between the group members; and, for the OK key:

If the highlighted line is “Add Contact”, open the Contact List screen of FIG. 16;

If the highlighted line is “Add Number”, open the Enter Number screen of FIG. 27;

If the highlighted line is “Delete Group”, delete the group. The Groups screen of FIG. 23 opens; and

If the highlighted line is one of the group members, open a menu that allows this member to be removed or saved to contacts.

Reference is now made to FIG. 26 which is a simplified pictorial illustration of a New Contact screen which is opened via the Contacts screen of FIG. 16 when the user selects the New Contact line. UI elements may include a Contact name edit box which contains the Contact's name (1-20 alphanumeric characters), and an OK soft key.

User actions may include:

0-9 keys—displays the corresponding character in the message box (default device behavior);

OK key—opens the Enter Number screen; and

CLR key—opens the Contacts screen.

Reference is now made to FIG. 27 which is a simplified pictorial illustration of a Enter Number screen used to enter the number of a recipient. It can be opened via the New Message Recipients Screen of FIG. 15, via the Update Group screen of FIG. 25 or via the Add Contact screen of FIG. 26. UI elements may include an OK soft key and a Contact number edit box which contains the Contact's number (e.g. 1-20 numeric characters).

User actions may include:

0-9 keys—displays the corresponding character in the message box (default device behavior); and

OK soft key:

When opened from the New Message Recipients screen of FIG. 15 the number is added to the message recipients list and the New Message Recipients screen opens;

When opened from the Update Group screen of FIG. 25, the number is added to the group members list and the Update Group screen of FIG. 25 opens;

When opened from the Add Contact screen of FIG. 26, the number is added to the group members list and the Contacts screen of FIG. 16 opens; and

CLR key—the previously displayed screen (one of the New Message Recipients screen of FIG. 15, the Group Members screen of FIG. 25, or the New Contact screen of FIG. 26) is displayed.

Reference is now made to FIG. 28 which is a Sent Items Actions menu constructed and operative in accordance with a preferred embodiment of the present invention which allows the user to reseed or delete a message in the sent items folder. UI elements may include OK and Cancel soft keys, and an Actions menu which may contain Resend and Delete options.

User actions may for example include:

Up/Down arrows—scrolls up/down between the menu items;

Cancel key—opens the Incoming Message screen; and

OK soft key: If the highlighted line is Resend—opens the New Message screen of FIG. 14. Once the user clicks OK in this screen the message may be sent to the recipients of the original message;

If the highlighted line is Delete—deletes the highlighted message and re-displays the Sent Items screen of FIG. 19.

Message Concatenation: Referring again to FIGS. 9-12, to allow users to send longer messages, and to support double-byte languages, each logical text message may comprise a sequence of several SMS messages which the system treats as a unit as described in detail herein. Each SMS message may include the following additional fields: Message ID, overall number of SMS messages composing the current text message, and current number of SMS message within the sequence of SMS message composing the current text message.

When composing messages, the overall number of characters contained in the text message is preferably displayed. e.g. in the New Message screen of FIG. 14, ignoring the specific breakdown into actual SMS messages. Other than this, the process and screens of composing a message may be similar to the process and interface employed to compose a one-SMS length message.

A message sent may in fact be composed of several SMS messages sent to each recipient. The sending message display may show “sending message 1 of 2” as long as the SMS messages composing the text message sent to the first recipient are being sent, and then display “sending messages 2 of 2”, etc.

The system of the present invention is typically actuated on the receipt of each SMS message. However, the New Message notification may be displayed to users only when all SMSs together forming the given text message have been received, regardless of the specific order in which they were received.

The incoming text message is typically displayed as a whole regardless of the actual SMS messages it is composed of. Only one entry is displayed in the Inbox/Sent Items folders for each text message, and the Incoming Message screen shows the whole of the message. If needed, [more]/[prey] options may be added in the Incoming

Message screen. If this is the case, a counter showing the number of the current screen out of the full list of screens the message is composed of may be displayed (e.g. 1 of 3, 2 of 3, etc).

Any suitable method may be employed to compose messages in accordance with the present invention. Three such methods are:

a. Use readable text SMS for the actual message text and a binary SMS for the recipient list

b. Use readable text SMS for both the message text and the recipient list

c. Like (b), however the recipient list is encoded i.e. the recipient list portion of the message is not in a readable format.

Preferred implementations of the above methods are now described in detail.

(a) Readable text SMS for message text and binary SMS for recipient list: The text SMS messages which comprise the message are preferably sent first followed by a binary SMS that contains the recipient list. All SMS messages (both text and binary) are preferably intercepted e.g. by functional units 300 in FIG. 4, 400 in FIG. 5 and 600 in FIG. 7). The binary SMS typically causes functional units 300 of FIG. 4, 400 of FIG. 5 and 600 on FIG. 7 to open and is ignored by devices which do not have the system of the present invention installed.

Some, e.g. the last 10, characters of each text SMS message may be reserved and may for example contain: Bytes 0-4: application marker; Byte 5: number of SMS messages in the current text message (1 byte); Byte 6: number of current SMS message in the sequence of the current text message (1 byte); Bytes 7-9: reserved for future user.

The remaining characters of each text SMS, typically excluding the binary SMS which contains the recipient list information, may contain the actual text. There may be several binary SMS message containing the recipient list data e.g. in case there are many recipients.

(b) Readable text SMS for both message text and recipient list: Typically, the text of the message is first sent followed by the recipient list. The recipient list is not necessarily sent in one SMS message (e.g. the beginning of the recipient list can be included on the last SMS that contains the message text and the remaining recipients can be included in the following SMS). Receipt of the last text SMS (“last” being used in this context in the sense that all other text SMS messages which are part of the same text message have been already received) typically actuates the system of the present invention.

The numbers included in the recipient list may appear in text format using a separator between each consecutive numbers (e.g. default separator: “#”). Some, e.g. the last 10, characters of each text SMS message may be reserved and may for example contain: Bytes 0-4: the application marker, Byte 5: number of SMS messages in the current text message (1 byte), Byte 6: number of current SMS message in the sequence of the current text message (1 byte), Bytes 7-8: reserved for future user, and Byte 9: in the last text SMS of a text message—the number of recipients, otherwise blank.

(c) Text SMS for message text using encoded recipient list: The text of the message is typically sent first, followed by the recipient list. The recipient list is not necessarily sent in one SMS message (e.g. the beginning of the recipient list can be included on the last SMS that contains the message text and the remaining recipients can be included in the following SMS). The “last” text SMS received typically actuates the system of the present invention.

The recipient list (i.e. the recipient numbers) are sent in their binary format. Some of the characters of each text SMS message are reserved; for example the last 10 bytes may be reserved as follows: Bytes 0-4: the application marker; Byte 5: number of SMS messages in the current text message (1 byte); Byte 6: number of current SMS message in the sequence of the current text message (1 byte); Bytes 7-8: reserved for future user; Byte 9: in the last text SMS of a text message—the number of recipients, otherwise blank.

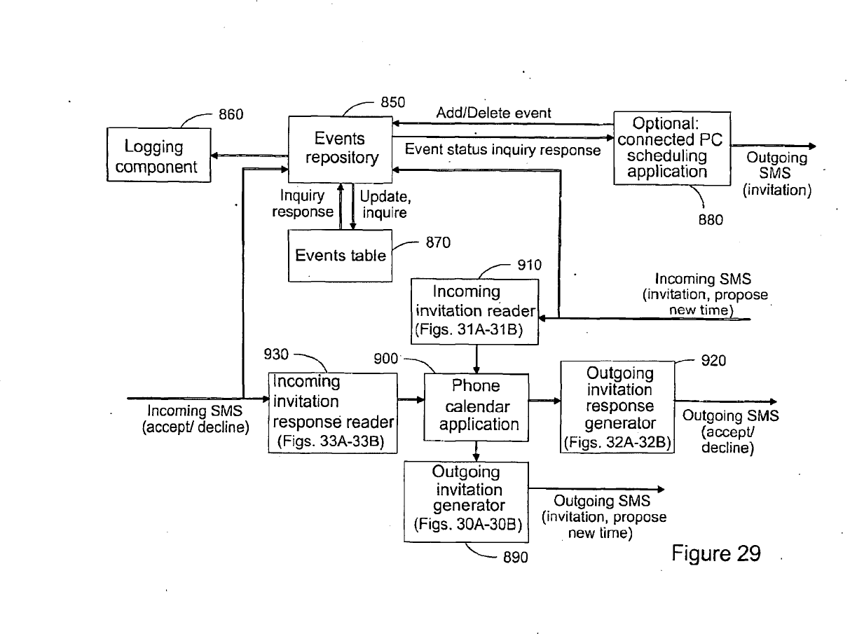

FIG. 29 is a simplified functional block diagram illustration of a mobile interactive invitation system constructed and operative in accordance with a preferred embodiment of the present invention. The system of FIG. 29 is typically installed in a mobile communication device such as a cellular telephone. Each invitation or other message generated by the system of FIG. 29 typically comprises a message of limited length such as an SMS, EMS or MMS message. The events table of FIG. 29 typically comprises some or all of the following information, regarding each event in the table: subject of event, date, start time (current and optionally, proposed changes if any), end time (current and optionally, proposed changes if any), attendee list, invitation status for each attendee.

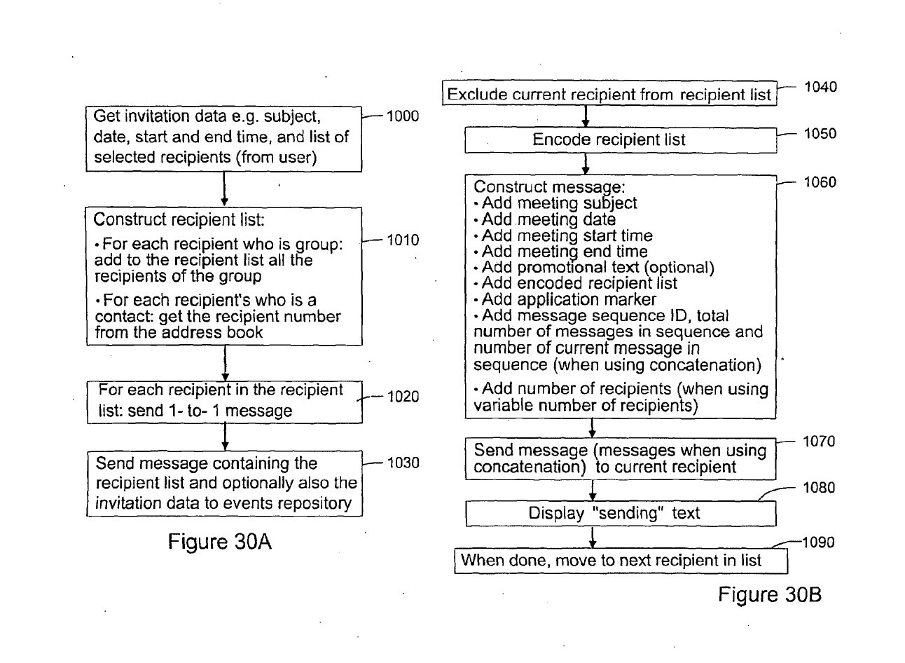

FIG. 30A is a simplified flowchart illustration of a preferred method of operation for the outgoing invitation generator 890 of FIG. 29.

FIG. 30B is a simplified flowchart illustration of a preferred method for performing the one-to one message sending step by unit 1020 in FIG. 30A.

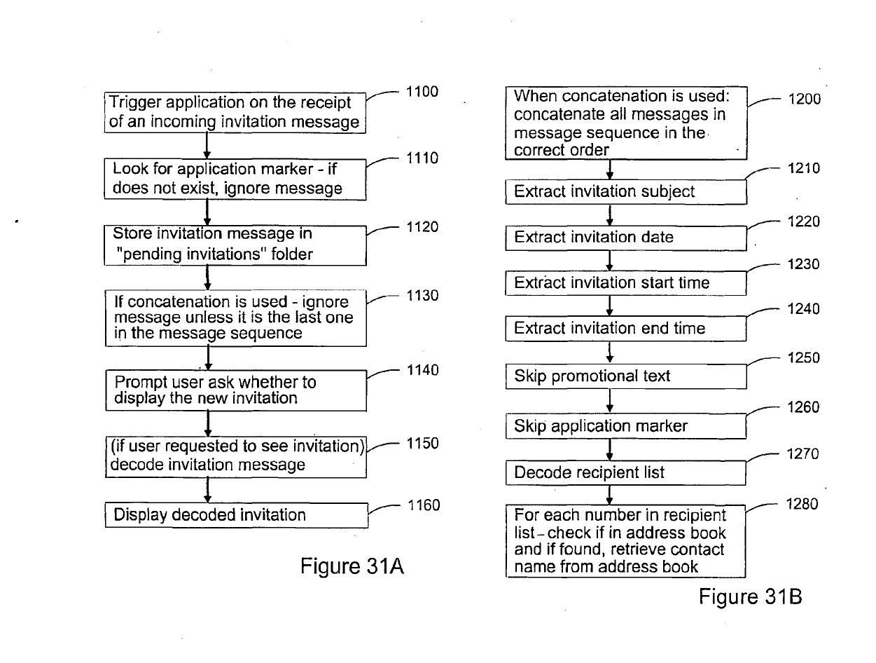

FIG. 31A is a simplified flowchart illustration of a preferred method of operation for the incoming invitation reader 910 of FIG. 29.

FIG. 31B is a simplified flowchart illustration of a preferred method for performing the invitation decoding step by unit 1150 in FIG. 31A.

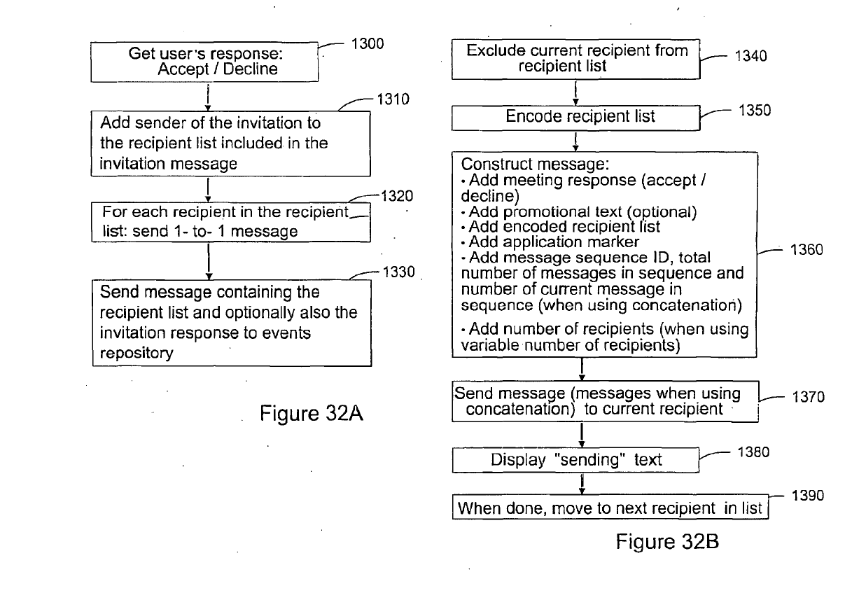

FIG. 32A is a simplified flowchart illustration of a preferred method of operation for the outgoing invitation response generator 920 of FIG. 29.

FIG. 32B is a simplified flowchart illustration of a preferred method for performing the one-to one message sending step by unit 1320 in FIG. 32A.

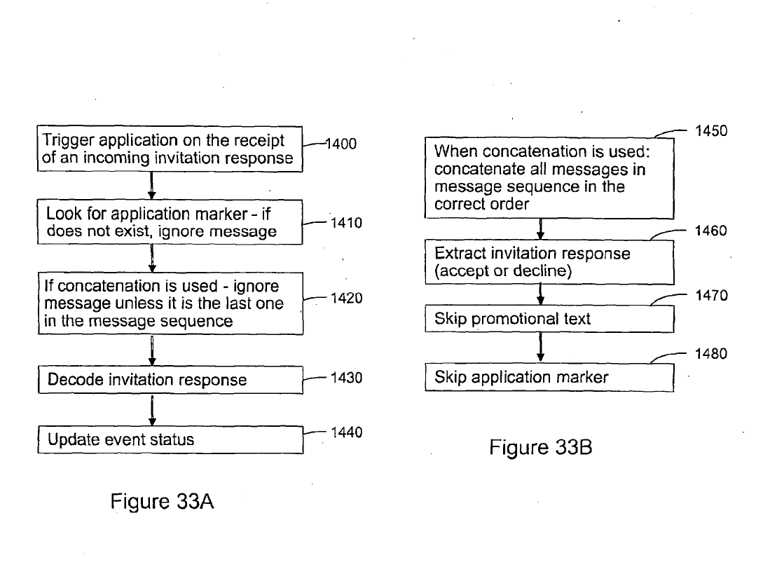

FIG. 33A is a simplified flowchart illustration of a preferred method of operation for the invitation response reader 930 of FIG. 29.

FIG. 33B is a simplified flowchart illustration of a preferred method for performing the invitation response decoding step by unit 1430 in FIG. 33A.

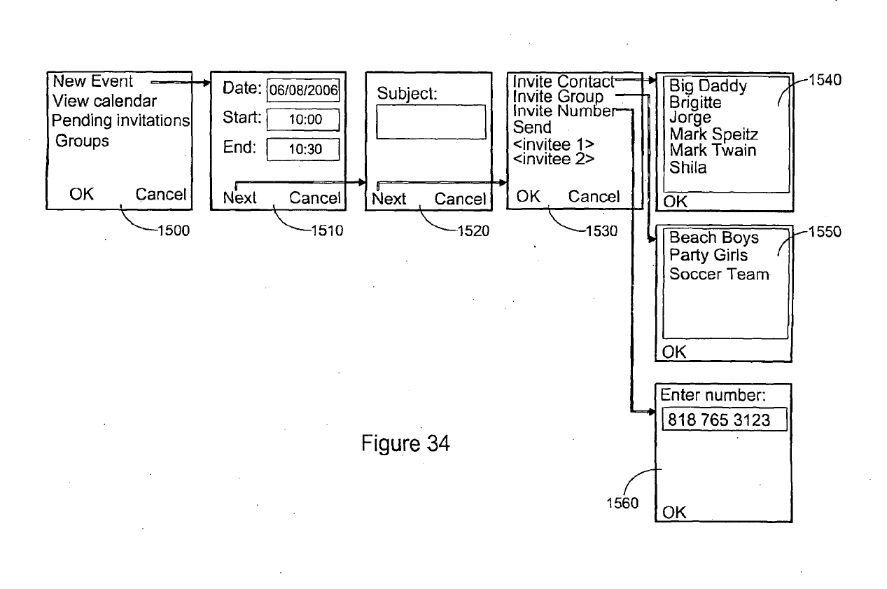

FIG. 34 is a simplified pictorial illustration of a first sequence of screenshots forming a first portion of a preferred user interface 900 serving users of the mobile interactive invitation system of FIG. 29, the first portion of the preferred user interface enabling users to initiate an event and to invite other users thereto.

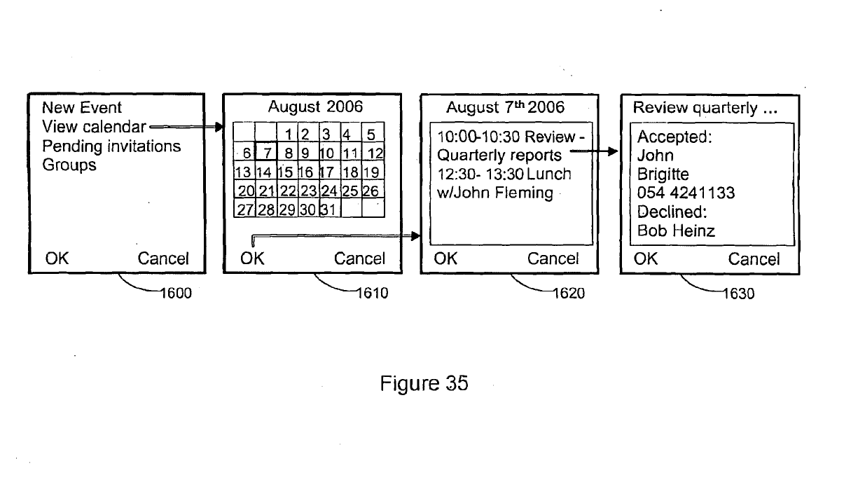

FIG. 35 is a simplified pictorial illustration of a second sequence of screenshots forming a second portion of the preferred user interface 900 serving users of the mobile interactive invitation system of FIG. 29, the second portion of the preferred user interface enabling users to view a calendar of events they are committed to.

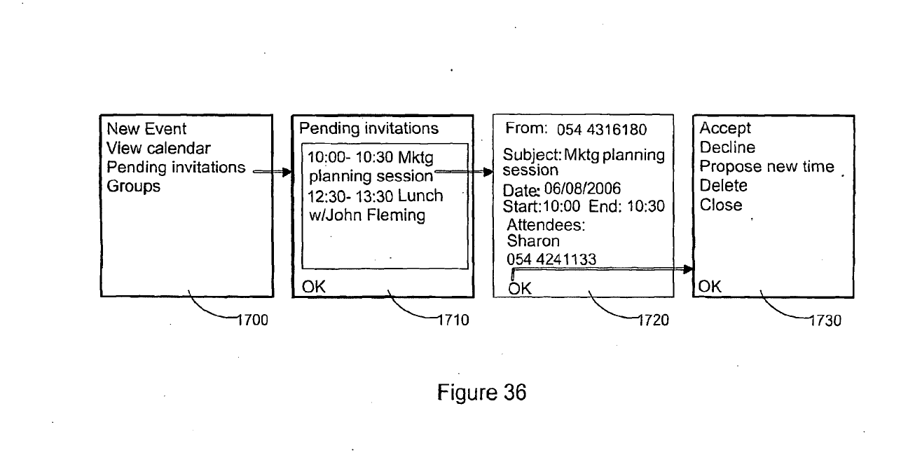

FIG. 36 is a simplified pictorial illustration of a third sequence of screenshots forming a third portion of the preferred user interface 900 serving users of the mobile interactive invitation system of FIG. 29, the third portion of the preferred user interface enabling users to view pending invitations which they may wish to accept.

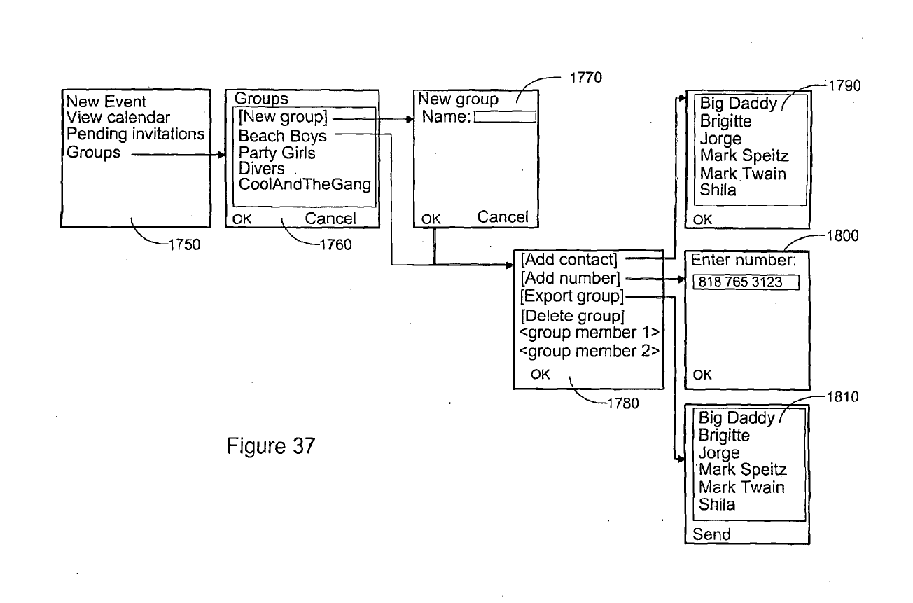

FIG. 37 is a simplified pictorial illustration of a fourth sequence of screenshots forming a fourth portion of the preferred user interface 900 serving users of the mobile interactive invitation system of FIG. 29, the fourth portion of the preferred user interface enabling users to define groups of contacts and preferably communicate such groups to others inside or outside that group.

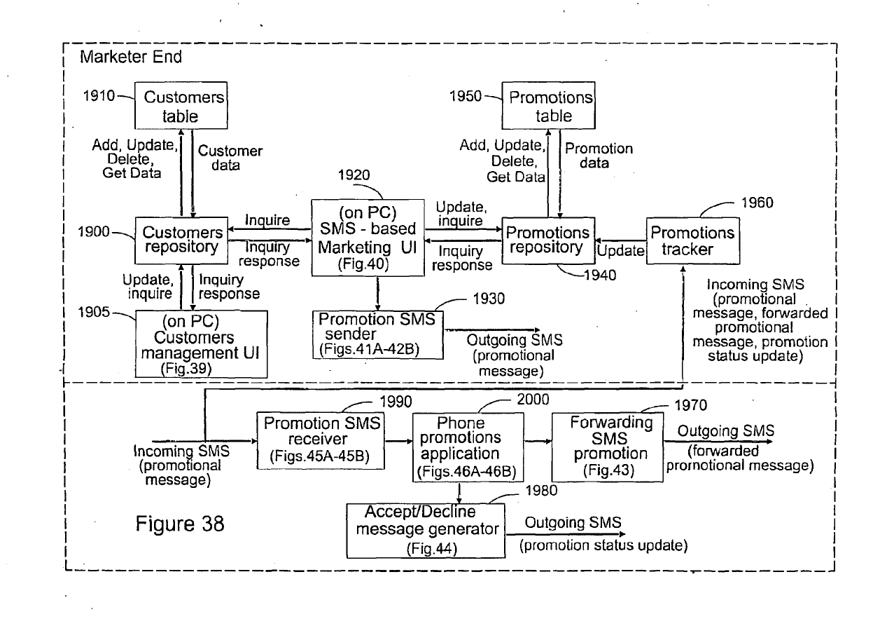

FIG. 38 is a simplified functional block diagram of an inter-consumer communication system constructed and operative in accordance with a preferred embodiment of the present invention. The customer end of the system of FIG. 38 is typically installed in a mobile communication device such as a cellular telephone. Each message generated by the system of FIG. 38 typically comprises a message of limited length, e.g. a 1-to-1 message, such as an SMS, EMS or MMS message. The system of FIG. 38 typically comprises a “marketers’ end” Which is installed in operative association with a marketer and a “customer end” which typically is installed in mobile communication devices of each of a multiplicity of potential customers.

The customers table 1910 may for example contain some or all of the following types of information: customer information such as name, telephone number, and/or address; definitions of groups; and customer history information. The promotions table 1950 may for example contain some or all of the following types of information: promotion information such as IDs, prices and quantities of various products; promotion status such as the number of persons who responded to the promotion; and customer-promotion association information such as which customers participated in which promotions. The SMS received by the promotions tracker 1960 may comprise a promotion message, a forwarded promotional message, or a promotion status update.

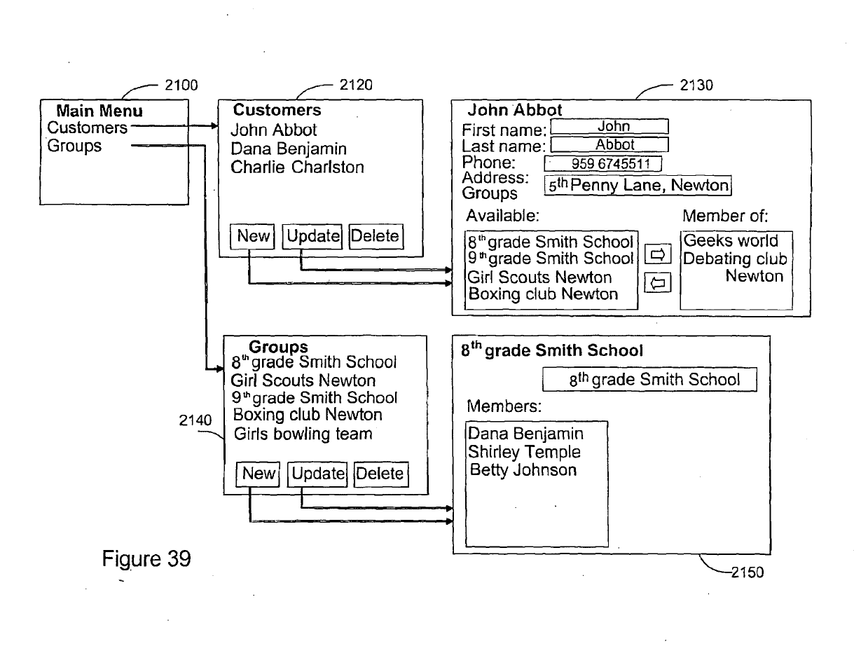

FIG. 39 is a simplified pictorial illustration of a sequence of preferred screen shots for the customer management user interface 1905 of FIG. 38.

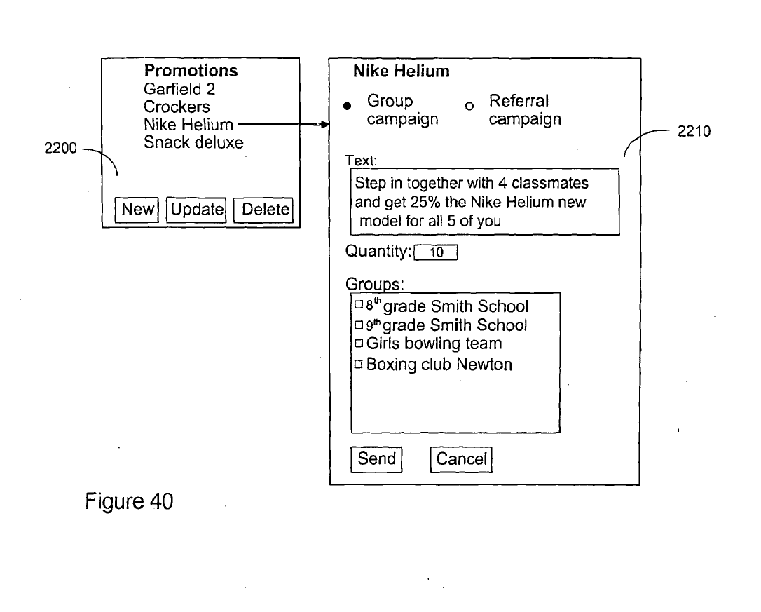

FIG. 40 is a simplified pictorial illustration of a sequence of preferred screen shots for the PC SMS-based marketing user interface 1920 of FIG. 38.

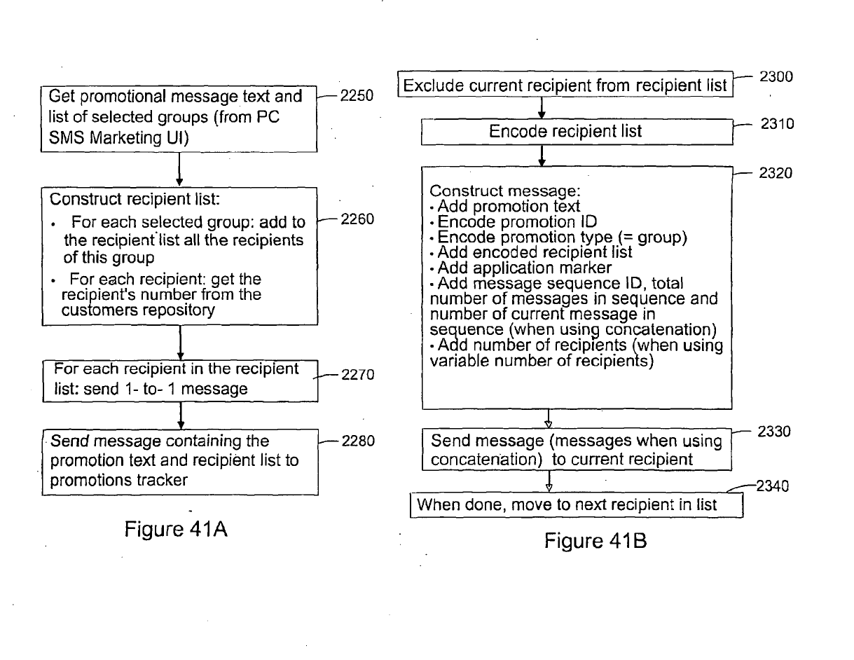

FIG. 41A is a simplified flowchart illustration of a preferred method of operation by which the promotion SMS sender 1930 of FIG. 38 sends group promotional messages.

FIG. 41B is a simplified flowchart illustration of a preferred method for performing the send 1-to-1 message step by unit 2270 of FIG. 41A.

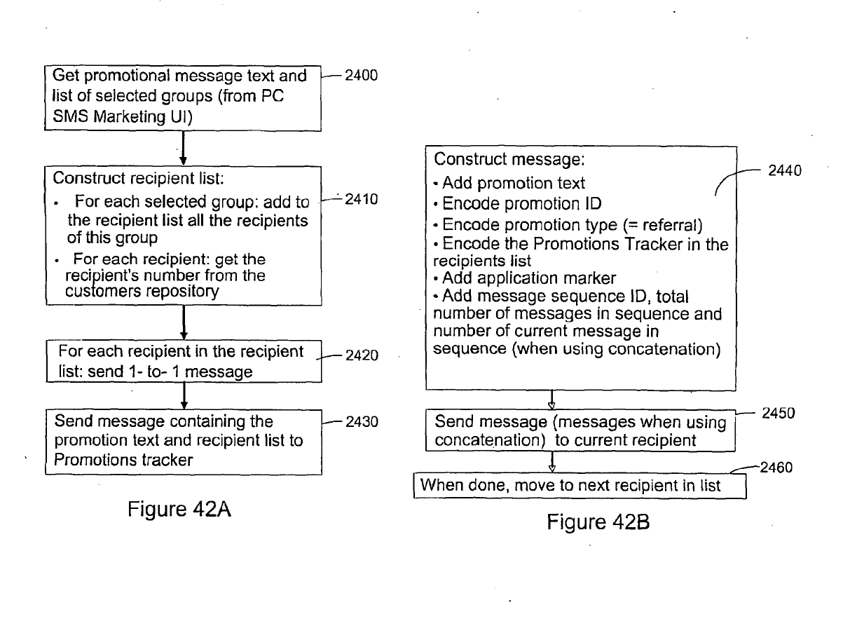

FIG. 42A is a simplified flowchart illustration of a preferred method of operation by which the promotion SMS sender 1930 of FIG. 38 sends referral offers.

FIG. 42B is a simplified flowchart illustration of a preferred method for performing the send 1-to-1 message step by unit 2420 of FIG. 42A.

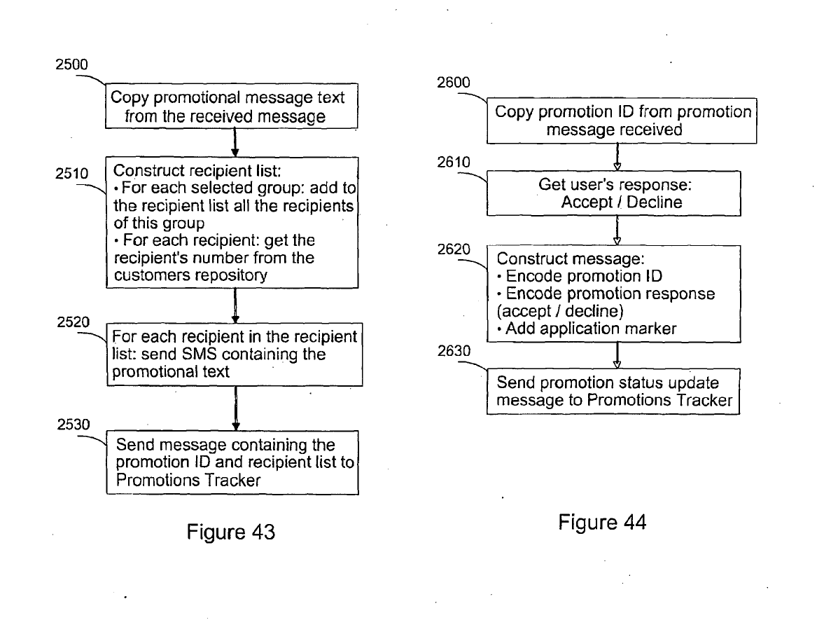

FIG. 43 is a simplified flowchart illustration of a preferred method of operation for the SMS promotion forwarding unit 1970 of FIG. 38.

FIG. 44 is a simplified flowchart illustration of a preferred method of operation for the accept/decline message generator 1980 of FIG. 38.

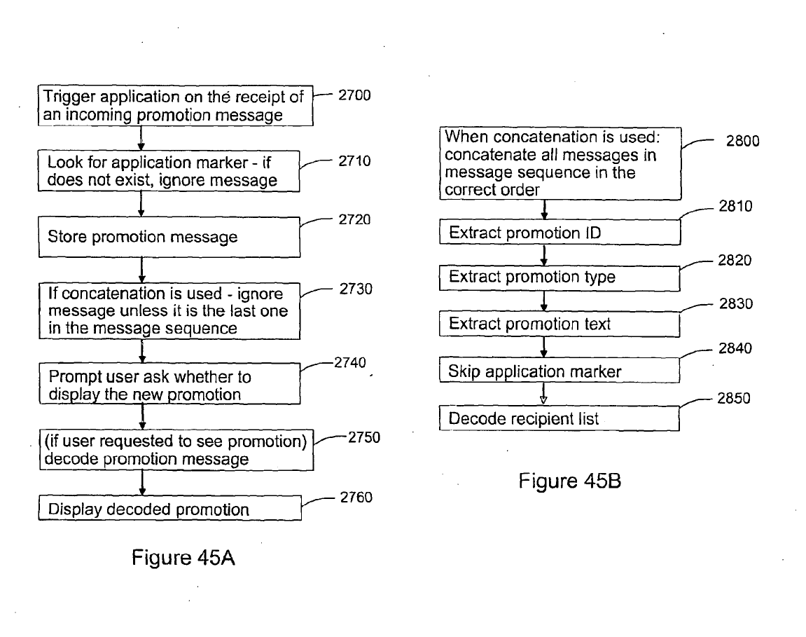

FIG. 45A s a simplified flowchart illustration of a preferred method of operation by which the promotion SMS receiver 1990 of FIG. 38 receives referral offers.

FIG. 45B is a simplified flowchart illustration of a preferred method for performing the message decoding step by unit 2750 of FIG. 45A.

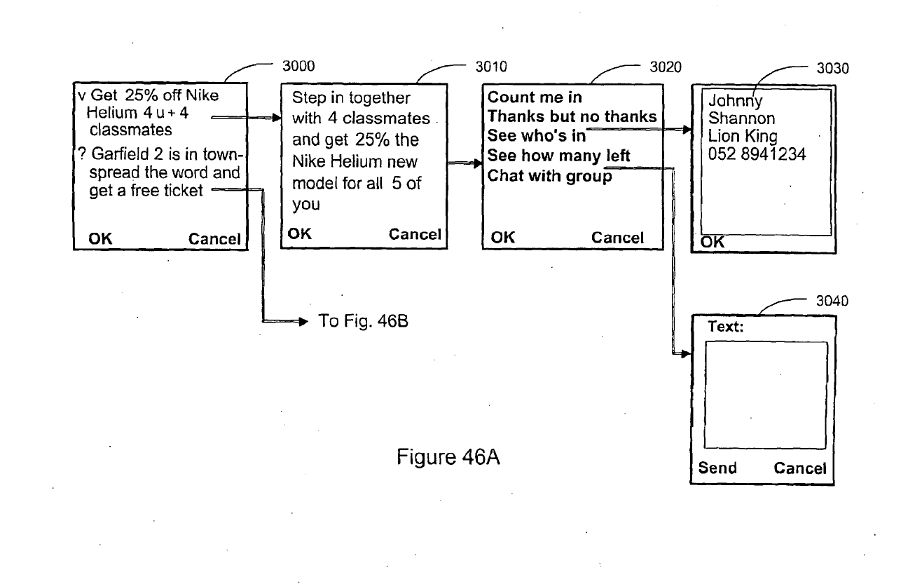

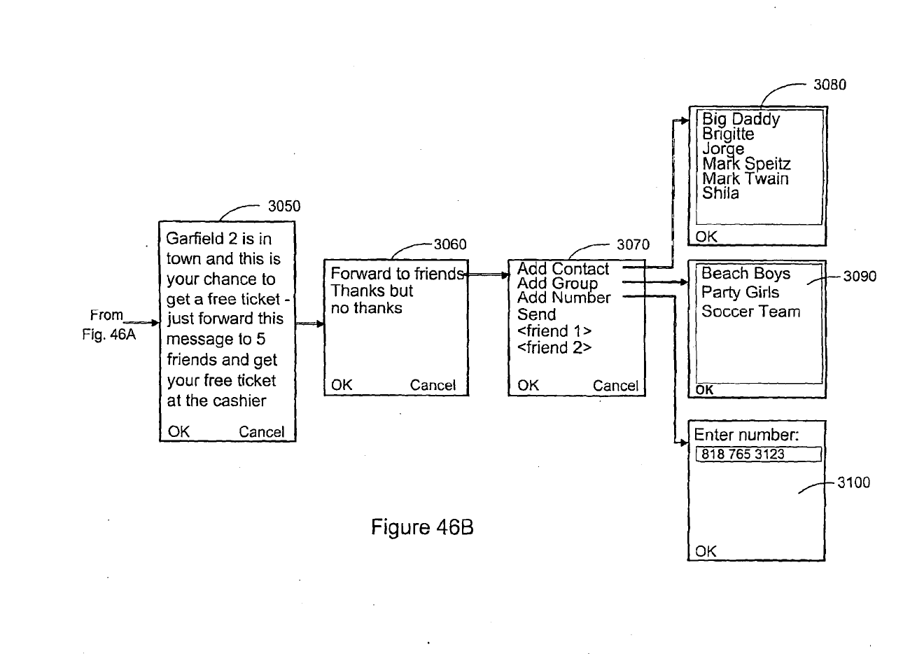

FIGS. 46A-46B, taken together, form a simplified pictorial illustration of a sequence of preferred screen shots for the “phone promotions application” unit 2000 of FIG. 38. The status of each of a plurality of group discount offers, or other promotions offered to a group and typically requiring interaction between the group's members in order to become eligible to benefit from the promotion, is preferably shown upon request by incrementing the number of users who have “signed up”, for each group discount offer or, more generally, promotion, separately. For example, if a group discount was offered if at least n members of a group “sign up”, the status of this offer may for example be (if n=5): “No-one has joined yet” or “1 has joined—only 3 to go if u join!” or “4 have joined—join and clinch the deal!”.

It is appreciated that the present invention is applicable to a wide variety of mobile applications in which messages are sent in which distribution lists may be embedded or otherwise associated therewith, such as but not limited to systems which communicate the following sometimes overlapping categories or types of messages: text messages; the MS-family including SMS, EMS and MMS; messages both verbal and non-verbal transmitted partially or wholly through a cellular telephone network serving either digital or non-digital mobile devices such as digital mobile phones; and messages sent through landline communication devices such as telephones or through handheld devices other than mobile telephones.

It is appreciated that software components of the present invention may, if desired, by implemented in ROM-type (read only memory) form e.g. ROM, EPROM or EEPROM. The software components may, generally, be implemented in hardware, if desired, using conventional techniques.

The present invention can be provided in conjunction with any suitable platform or framework such as but not limited to those based on or similar to the following technologies some of which are registered trademarks: SIM application; SIM toolkit application; USIM application; Java Card applet; Toolkit applet; Card application; application embedded on a mobile phone's hardware, memory, disk, memory card or on any other form of storage on the device; J2ME (Java 2 Micro Edition); Symbian OS, Wipi, i-mode, WAP, BREW (Binary Runtime Environment for Wireless—Qualcomm), and Palm OS.

Features of the present invention which are described in the context of separate embodiments may also be provided in combination in a single embodiment. Conversely, features of the invention which are described for brevity in the context of a single embodiment may be provided separately or in any suitable subcombination. For example, components and blocks of screenshots, flowcharts and functional block diagrams may be omitted, modified and combined as appropriate.

1. A many-to-many mobile messaging method comprising:
sending a sequence of messages using a mobile communication device, wherein at least some of the messages are sent to a plurality of recipients and comprise message content and a set of destination indications for at least two of said plurality of recipients, including displaying, to an individual one of said plurality of recipients, information identifying to the individual one of said plurality of recipients, other individual ones of said plurality of recipients.

2.-10. (canceled)

11. A many-to-many mobile messaging system comprising:
a mobile sending encoder operative to receive from a user message content and indications of a plurality of recipients, each having a destination indication, to whom the user message content is to be sent, and to send a sequence of messages, wherein at least some of said messages are sent to the plurality of recipients and comprise said message content and a set of the destination indications for at least some of said plurality of recipients.

12.-17. (canceled)

18. An interactive invitation system operative in conjunction with a mobile communication network and comprising:
at least one invitation encoder operative to receive from an inviter's mobile communication device, invitation content and indications of a plurality of invitees, each having a destination indication, to whom the invitation content is to be sent and to send, via a mobile communication network, a sequence of invitation messages, wherein at least some of said invitation messages are sent to the plurality of recipients and comprise said invitation content and a set of the destination indications for at least some of said plurality of invitees; and
an invitation decoder operative to receive from an inviter's mobile communication device, via the network, an invitation message comprising invitation content and a set of destination indications for at least some of the plurality of invitees' mobile communication devices, said invitation decoder being operative to display said invitation message to an invitee, to receive feedback from said invitee, and to communicate said feedback to at least a portion of said set of destination indications.

19.-31. (canceled)
